(19) United States
(12) Patent Application Publication
(10) Pub. No.: US 2009/0155495 A1
(43) Pub. Date: Jun. 18, 2009

(54) PROCESS FOR PRODUCING CELLULOSE ACYLATE FILM, CELLULOSE ACYLATE FILM, POLARIZER, AND LIQUID-CRYSTAL DISPLAY

(75) Inventors: Takayuki Suzuki, Tokyo (JP); Satomi Kawabe, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA OPTO, INC., Tokyo (JP)

(21) Appl. No.: 12/299,856

(22) PCT Filed: Apr. 16, 2007
(86) PCT No.: PCT/JP2007/058253

§ 371 Date: Nov. 6, 2008

(30) Foreign Application Priority Data
May 12, 2006 (JP) 2006-133484

(51) Int. Cl. B29C 47/88; B29C 47/14; B29D 7/01; G02B 5/30; C09K 3/00

(52) U.S. Cl. 428/1.31; 264/210.1; 264/210.6; 428/533; 252/182.12

(57) ABSTRACT

A process for cellulose acylate film production which is sufficiently effective in reducing viscosity and in reducing moisture permeability. The cellulose acylate film does not suffer bleeding, i.e., the phenomenon in which a component separates out or volatilizes from the cellulose acylate film, has high flatness, is inhibited from having streak unevenness, and has high evenness. Even through long-term storage, the film does not suffer film deformation failures such as ridge failures or protrusion failures. This process for cellulose acylate film production comprises forming a cellulose acylate film by the melt casting method, and is characterized in that the cellulose acylate film contains at least one compound represented by the following general formula (1) and that the cellulose acylate film extruded from a casting dye in the film formation by melt casting is pressed between a touch roll having an elastically deformable surface and a cooling roll to produce the target film.

### TECHNICAL FIELD

The present invention relates to process for producing a cellulose acylate film, a cellulose acylate film, a polarizing plate employing the above cellulose acylate film, and a liquid crystal display.

### BACKGROUND ART

Cellulose acylate film has been employed as a photographic negative film support, and in polarizing plates as a film which protects polarizers employed in liquid crystal displays, due to its high transparency, low birefringence, and ease of adhesion to polarizers.

In recent years, the production amount of liquid crystal displays has markedly increased due to the thin depth and light weight, and the demand is increasing. Further, television sets, which employ a liquid crystal display, exhibit features such as thinness and light weight. Thereby, large-sized television sets, production of which was not possible by employing Braun tubes, have been produced. Along with that trend, demand for polarizers and polarizer protecting films has been increasing.

Heretofore, these cellulose acylate films have been produced mainly employing a solution-casting method. The solution-casting method, as descried herein, refers to a film forming method in which a solution prepared by dissolving cellulose acylate in solvents is cast to form film and solvents are evaporated and dried to produce film. The film which is cast employing the solution-casting method exhibits high flatness, whereby by employing the resulting film, it is possible to produce uniform and high image quality liquid crystal displays.

However, an inherent problem of the solution-casting method is the necessity of a large volume of organic solvents followed by a high environment load. The cellulose acylate film is cast employing halogen based solvents which result in a high environment load, due to its solubility characteristics. Consequently, it has particularly demanded to reduce the amount of used solvents, whereby it has been difficult to increase the production of cellulose acylate film employing the solution-casting method.

Accordingly, in recent years, experiments have been conducted in which cellulose acylate is subjected to melt-casting for the use of silver salt photography (Patent Document 1) and as a polarizer protective film (Patent Document 2). However, cellulose acylate is a polymer which exhibits a very high viscosity when melted and also exhibits a very high glass transition point. As a result, when cellulose acylate is melted, extruded from a die and cast onto a cooling drum or belt, it is difficult to achieve leveling, and after extrusion, solidification occurs in a relatively short time, whereby a major problem has been that flatness of the resulting film is inferior to that of the a solution-casting film.

Display unevenness may be produced due to stripe-shaped unevenness appeared in the film when the film is incorporated in a liquid crystal display. It has been required to improve such unevenness.

In order to lower the melt viscosity and glass transition point of organic polymers such as cellulose acylate, it is known that addition of plasticizers is effective.

In above Patent Documents 1 and 2, employed are phosphoric acid plasticizers such as triphenyl phosphate or phenylenebisdiphenyl phosphate. However, the result of investigations conducted by the inventors of the present invention has clarified that in these phosphoric acid plasticizers, phosphoric acid esters undergo decomposition due to moisture sorption or heating, resulting in generation of phosphoric acid, whereby problems occur in which generated phosphoric acid degrades cellulose acylate and a film is stained.

In the solution-casting, known as plasticizers, other than phosphoric acid esters, which are employed in cellulose acylate, are ethylene glycol based plasticizers or polyhydric alcohol based esters which are esters of trihydric or higher alcohol with carboxylic acids (for example, Patent Document 3). Plasticizers composed of polyhydric alcohol-carboxylic acid exhibit relatively high chemical stability, and even when hydrolyzed, do not generate strong acids which degrade cellulose acylate, whereby they are preferable plasticizers for casting of cellulose acylate. However, most of them are alkyl ester based, resulting in insufficient effects to lower water vapor permeability. Further, there are disclosed polyhydric alcohol-aromatic carboxylic acid and polyhydric alcohol-cycloalkylcarboxylic acid based esters (for example, Patent Document 4). However, it has been found that such compounds having a ring structure result in insufficient effects to lower viscosity as a plasticizer during melt-casting of cellulose acylate, whereby problems occur in which it is not possible to prepare cellulose acylate films which exhibit flatness.

Further, there was a problem of bleeding out of a plasticizer, i.e., deposition or evaporation of a plasticizer getting out of the film.

In addition, regarding a melt film formation, Patent Documents 3 & 4 have no description about more advantageous production methods, and their technologies are intrinsically different from the technologies of the present invention aiming the melt film formation.

Furthermore, methods have been proposed in which an optical film is produced employing the melt-casting film formation method (for example, refer to Patent Documents 5 & 6). Patent Document 5 has proposed a method in which molten resins are pressed in a circular arc state between a cooling roll, whose temperature is uniformly maintained across the width, and an endless belt to cool down the resins. Patent Document 6 has proposed a method in which molten resins are pressed between two cooling drums to cool down the resins-However, since the heat melted cellulose resins exhibit high viscosity, a film produced by a melt-casting film formation method is inferior in flatness to a film produced by a solution-casting film formation method, and specifically the aforesaid film has shortcomings such that the film tends to exhibit the die line and unevenness in thickness.

Accompanying the increase in a large sized liquid crystal display device, the film web material has been demanded to be wider and longer in roll. Then the film web material tends to be wider and the weight thereof tends to increase, resulting in being likely to cause a failure, called a horseback failure, when the film is stored for an extended period of time. The term “horseback failure” means that a film web material roll is deformed in U-shape like a horseback and exhibits a belt-shaped protrusion near the central part thereof in a pitch of about 2 to 3 cm. The failure leaves a deformation on the film causing a problem that the film surface is observed to be deformed when the film is finished as a polarizing plate. The cellulose acylate film, which is provided on the outermost surface of a liquid crystal display, is subjected to a clear-hard process, an anti-glare process, or an anti-reflection process. When the above processes are carried out, if the surface of the cellulose acylate film is deformed, the deformation causes coating unevenness or vapor-deposition unevenness, resulting in significant decrease in a production yield. Heretofore, the occurrence of the horseback failure has been reduced by reducing a dynamic friction coefficient between bases or by controlling the height in knurling (embossing) on both edges of the film. It is also known that the horseback failure is caused by the winding core being deflected by the film load (for example refer to Patent Document 7), and it is disclosed that the occurrence of the horseback failure was reduced by controlling the surface roughness of the winding core of the optical film web material. However, a much wider cellulose acylate film corresponding to the recent liquid crystal TV has been required, and the above-described technologies are found to be insufficient to meet the requirement. Therefore, further methods have been desired.

Patent Document 1: Japanese Patent Application Publication (hereinafter also referred to as JP-A) No. 6-501040

### Patent Document 2: JP-A No. 2000-352620

### Patent Document 3: JP-A No. 11-246704

### Patent Document 4: JP-A No. 2003-12823

### Patent Document 5: JP-A No. 10-10321

### Patent Document 6: JP-A No. 2002-212312

### Patent Document 7: JP-A No. 2002-3083

### DISCLOSURE OF THE INVENTION

### Problems to be Solved by the Invention

It is an object of the present invention to provide a cellulose acylate film (hereinafter, also simply referred to as an optical film or a film) exhibiting sufficient effects of viscosity reducing and moisture permeability reducing, and further exhibiting high uniformity of excellent flatness and suppressed streak irregularity achieved by a method employing additives which do not cause bleedout such as precipitation and volatilization outside the cellulose acylate film and an elastic touch roll, and it is another object to provide a liquid crystal display exhibiting a high image quality by employing the above film. It is yet another object of the present invention to provide an optical film exhibiting high productivity wherein deformation failures of the film web such as a horseback failure or a protrusion failure does not occur despite long-term storage. In particular, the aforesaid film demonstrates its advantages in a thin optical film having a width of not less than 1,350 mm, Further, it is still another object of the present invention to provide a cellulose acylate film by the melt film formation method without using a halogen based solvent a having heavy environmental load.

### Means to Solve the Problems

The present inventors have made efforts to solve the aforementioned problems, and have found out that by incorporating a specific glycerin ester compound, and by a concurrent use of a cooling method employing an elastic touch roll, a cellulose acylate film can be provided, exhibiting sufficient effects of viscosity reducing and moisture permeability reducing, and further exhibiting no bleedout of additives, and exhibiting excellent flatness and suppression of streak irregularity even by a production method employing a melt casting method, and further exhibiting no deformation failures of film web material such as a horseback failure and a protrusion failure, whereby achieving the present invention.

The above-described issues of the present invention were dissolved by the constitutions below.

Item 1: A production method of a cellulose acylate film formed by a melt casting film formation method, wherein the aforesaid cellulose acylate film incorporates at least one compound represented by Formula (1) below, and the aforesaid cellulose acylate film extruded from a casting die during the melt casting film formation is produced by being pressed between a touch roll whose surface is elastically deformable and a cooling roll.

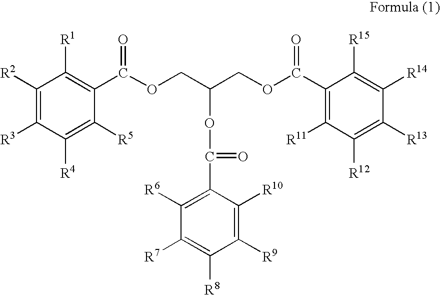

(wherein each of R¹ to R¹⁵ independently represents a hydrogen atom, a cycloalkyl group, an aralkyl group, an alkoxy group, a cycloalkoxy group, an aryloxy group, an aralkyloxy group, an acyl group, a carbonyloxy group, an oxycarbonyl group, or oxycarbonyloxy group, and these groups may further be substituted with a substituent.

Item 2: A production method of a cellulose acylate film of above-described Item 1, wherein the above cellulose acylate film incorporates a compound represented by Formula (1) in an amount of from 1% to 25% by mass.

Item 3: A production method of a cellulose acylate film of the above-described Item 1, wherein a cellulose acylate employed in the production of the above cellulose acylate film exhibits an acyl group total carbon number (the sum of the products of the substitution degree of each acyl group substituted into a glucose unit in the cellulose acylate and the number of carbons) of from 6.2 to 7.5.

Item 4: A production method of a cellulose acylate film of the above-described Item 3, wherein the cellulose acylate has a total substitution degree of acyl groups of 2.95 or less.

Item 5: A production method of a cellulose acylate film of any one of the above-described Items 1 to 4, wherein the above cellulose acylate incorporates as a substituent at least one selected from the group consisting of an acetyl group, a propionyl group, a butyryl group, and an n-pentanoyl group.

Item 6: A production method of a cellulose acylate film of any one of the above-described Items 1 to 5, wherein the above cellulose acylate film incorporates at least one selected from the group consisting of a hindered phenol antioxidant, a phosphorous antioxidant, and a carbon radical scavenger.

Item 7: A production method of a cellulose acylate film of the above-described Item 6, wherein the above cellulose acylate film incorporates a lactone compound as the above carbon radical scavenger.

Item 8: A production method of a cellulose acylate film of the above-described Item 1, wherein the extrusion temperature from a casting die of the above cellulose acylate film is from 200° C. to 300° C.

Item 9: A production method of a cellulose acylate film of the above-described Item 8, wherein the extrusion temperature from a casting die of the above cellulose acylate film is from 230° C. to 260° C.

Item 10: A production method of a cellulose acylate film of the above-described Item 1, wherein the line pressure between the above-described touch roll and the above-described cooling roll is from 10 N/cm to 150 N/cm.

Item 11: A cellulose acylate film, wherein the cellulose acylate film is produced by a method described in any one of the above Items 1 to 10.

Item 12: A polarizing plate, wherein the cellulose acylate film which is described in the above Item 11 is employed as a polarizing plate protective film.

Item 13: A liquid crystal display device, wherein the liquid crystal display device employs the polarizing plate described in the above Item 12

### EFFECTS OF THE INVENTION

According to the present invention, it was achieved, via a melt film formation method without using a halogen based solvent having a heavy environmental load, to provide a cellulose acylate film exhibiting sufficient viscosity reducing and moisture permeability reducing effects, and further exhibiting excellent flatness and suppressed streak irregularity achieved by a method employing additives which exhibit no bleedout such that the additives are precipitated or volatilized outside the cellulose acylate film and an elastic touch roll; and further it was achieved to provide an optical film exhibiting an excellent uniformity, and a liquid crystal display exhibiting a high image quality.

### BRIEF DESCRIPTION OF THE DRAWINGS

FIG. 1 is a schematic flow sheet representing one embodiment of an apparatus for embodying the manufacturing method of the optical film as an embodiment of the present invention;

FIG. 2 is an enlarged flow sheet representing the major portion of the manufacturing equipment;

FIG. 3 (a) is an external view of the major portions of the flow casting die;

FIG. 3(b) is a cross sectional view of the major portions of the flow casting die;

FIG. 4 is a cross sectional view of the first embodiment of the rotary pinch member;

FIG. 5 is a cross sectional view representing the plane surface perpendicular to the rotary axis in the second embodiment of the rotary pinch member;

FIG. 6 is a cross sectional view representing the plane surface including the rotary axis in the second embodiment of the rotary pinch member; and

FIG. 7 is an exploded perspective view schematically representing the structure of the liquid crystal display.

FIG. 8 is a schematic drawing showing the state of storing the web material of the cellulose ester film

### DESCRIPTION OF SYMBOLS

1. extruder
2. filter
3. static mixer
4. flow casting die
5. rotary support member (first cooling roll)
6. rotary pinch member (touch roll)
7. rotary support member (second cooling roll)
8. rotary support member (third cooling roll)
9, 11, 13, 14, 15. transport roll
10. cellulose acylate film
16. winding apparatus
21a, 21b. protect film
22a, 22b retardation film
23a, 23b. slow axis direction in film
24a, 24b. transmitting direction in polarizer
25a, 25b. polarizer
26a, 26b. polarizing plate
27. liquid crystal cell
29. liquid crystal display device
31. die body
32. slit
41. metallic sleeve
42. elastic roller
43. metallic inner cylinder
44. rubber
45. cooling water
51. outer cylinder
52. inner cylinder
53. space
54. coolant
55a, 55b. rotary shaft
56a, 56b. outer cylinder support flange
60. fluid bush
61a, 61b. inner cylinder support flange
62a. 62b. intermediate passage
110. roll shaft body
117. support plate
118. mount
120. web material of cellulose ester film

### PREFERRED EMBODIMENTS TO CARRY OUT THE INVENTION

The optical film as an object of the present invention refers to a functional film used in various types of displays such as a liquid crystal display, plasma display and organic electroluminescent display—especially in a liquid crystal display. It includes a polarizing plate protective film, retardation film, antireflection film, enhanced brightness film, and optical compensation film with enlarged viewing angle.

The most preferred embodiments to achieve the present invention will now be described, however the present invention is not limited thereto.

The present invention makes it possible to prepare a cellulose acylate film which exhibits desired flatness, as well as excellent optical characteristics and dimensional stability, even employing cellulose resins which have been subjected to melt-casting.

By employing the above cellulose acylate film, it is possible to produce an optical film such as a high quality polarizing plate protecting film, an antireflection film, or a retardation film, and further to produce liquid crystal displays exhibiting a high display quality.

The inventors of the present invention conducted diligent investigations and discovered the following. In order to produce cellulose acylate films which exhibit excellent optical characteristics and dimensional stability as well as desired flatness, in a casting method of a heat-melt method, namely in film casting employing a melt-casting method, which does not use halogen based solvents of a high environment load, the flatness of the resulting cellulose acylate films was markedly enhanced by selecting some specific compounds as a plasticizer incorporated in the cellulose esters.

Namely, in the melt-casting method in which melted cellulose ester was cast onto a cooling drum or belt, it was discovered that by employing the plasticizers according to the present invention, leveling was easily achieved, whereby a film of high flatness was easily produced.

The cellulose acylate film of the present invention is characterized in incorporating, as a plasticizer in an amount of 1-25 percent by weight, ester compounds having a structure which is represented by above Formula (1). When the above amount is 1 percent by weight or more, advantageous effects to improve flatness can be obtained, while when it is less than 25 percent by weight, bleeding-out can be prevented and storage stability of the film can be improved, both of which are desired. The cellulose acylate film is more preferred which incorporates the plasticizers in an amount of 3-20 percent by weight, and is still more preferred which incorporates the plasticizers in an amount of 5-15 percent by weight.

Plasticizers, as described herein, commonly refer to additives which decrease brittleness and result in enhanced flexibility upon being incorporated in polymers. In the present invention, plasticizers are added so that the melting temperature of a cellulose ester resin is lowered, and at the same temperature, the melt viscosity of a cellulose ester resin is lower than that of film constituting materials incorporating plasticizers. Further, addition is performed to enhance hydrophilicity of cellulose ester so that the water vapor permeability of cellulose acylate films is improved. Therefore, the plasticizers of the present invention have a property of decreasing water vapor permeability.

The melting temperature of film constituting materials, as described herein, refers to the temperature at which the above materials are heated to result in a state of fluidity. In order that cellulose ester results in melt fluidity, it is necessary to heat cellulose ester to a temperature which is at least higher than the glass transition temperature. At or above the glass transition temperature, the elastic modulus or viscosity decreases due to heat absorption, whereby fluidity results. However, at higher temperatures, cellulose ester melts and simultaneously undergoes thermal decomposition to result in a decrease in the molecular weight of the cellulose ester, whereby the dynamical characteristics of the resulting film may be adversely affected. Consequently, it is necessary to melt cellulose ester at a temperature as low as possible. Lowering the melting temperature of film constituting materials is achieved by the addition of plasticizers, which exhibit a melting point which is equal to or lower than the glass transition temperature. Polyhydric alcohol ester based plasticizers, which have a structure which is formed by condensing the organic acid represented by above Formula (1) and polyhydric alcohol, lower the melting temperature of the cellulose ester and exhibit preferred process adaptability due to minimal volatility during the melt-casting process and after production. Further, optical characteristics, dimensional stability, and flatness of the resulting cellulose acylate films are improved.

In above Formula (1), R¹-R¹⁵ each represent a hydrogen atom, a cycloalkyl group, an aryl group, an aralkyl group, an alkoxy group, a cycloalkoxy group, an aryloxy group, an aralkyloxy group, an acyl group, a carbonyloxy group, an oxycarbonyl group, or an oxycarbonyloxy group, any of which may be further substituted None of R₁-R₆ represent a hydrogen atom. L represents a divalent linking group, which includes a substituted or unsubstituted alkylene group, an oxygen atom or a direct bond.

Preferred as the cycloalkyl group represented by R¹-R¹⁵ is a cycloalkyl group having 3-8 carbon atoms, and specific examples include cycloproyl, cyclopentyl and cyclohexyl groups. These groups may be substituted. Listed as preferred substituents are a halogen atom such as a chlorine atom or a bromine atom, a hydroxyl group, an alkyl group, an alkoxy group, an aralkyl group (this phenyl group may further be substituted with a halogen atom), a vinyl group, an alkenyl group such as an aryl group, a phenyl group (this phenyl group may further be substituted with an alkyl group, or a halogen atom), a phenoxy group (this phenyl group may further be substituted with an alkyl group or a halogen atom), an acetyl group, an acyl group having 2-8 carbon atoms such as a propionyl group, an acetyloxy group, or a non-substituted carbonyloxy group having 2-8 carbon atoms such a propionyloxy group.

The aralkyl group represented by R¹-R¹⁵ includes a benzyl group, a phenetyl group, and a 7-phenylpropyl group, which may be substituted. Listed as the preferred substituents may be those which may be substituted for the above cycloalkyl group.

The alkoxy group represented by R¹-R¹⁵ include an alkoxy group having 1-8 carbon atoms. The specific examples include an methoxy group, an ethoxy group, an n-propoxy group, an n-butoxy group, an n-octyloxy group, an isopropoxy group, an isobutoxy group, a 2-ethylhexyloxy group, or a t-butoxy group, which may be substituted. Listed as preferred substituents may, for example, be a chlorine atom, a bromine atom, a fluorine atom, a hydroxyl group, an alkoxy group, a cycloalkoxy group, an aralkyl group (this phenyl group may be substituted with an alkyl group or a halogen atom), an alkenyl group, a phenyl group (this phenyl group may further be substituted with an alkyl group or a halogen atom), an aryloxy group (for example, a phenoxy group (this phenyl group may further be substituted with an alkyl group or a halogen atom)), an acetyl group, an acyl group such as a propionyl group, an acyloxy group such as a propionyloxy group having 2-8 carbon atoms, or an arylcarbonyloxy group such as a benzoyloxy group.

The cycloalkoxy groups represented by R¹-R¹⁵ include an cycloalkoxy group having 1-8 carbon atoms as an unsubstituted cycloalkoxy group. Specific examples include a cyclopropyloxy, cyclopentyloxy and cyclohexyloxy group, which may be substituted. Listed as the preferred substituents may be those may be substituted to the above cycloalkyl group.

The aryloxy groups represented by R¹-R¹⁵ include a phenoxy group having 1-8 carbon atoms as an unsubstituted cycloalkoxy group. This phenyl group may be substituted with the substituent listed as a substituent such as an alkyl group or a halogen atom which may substitute to the above cycloalkyl group.

The aralkyloxy group represented by R¹-R¹⁵ includes a benzoyloxy group, which way further be substituted. Listed as the preferred substituents may be those which may be substituted for the above cycloalkyl group.

The acyl group represented by R¹-R¹⁵ includes an unsubstituted acyl group having 2-8 carbon atoms such as an acetyl group (an alkyl, alkenyl, or alkynyl group is included as a hydrocarbon group of the acyl group), which may further be substituted. Listed as the preferred substituents may be those which may be substituted for the above cycloalkyl group.

The carbonyloxy group represented by R¹-R¹⁵ includes an unsubstituted acyloxy group (an alkyl, alkenyl, or alkynyl group is included as a hydrocarbon group of the acyl group) having 2-8 carbon atoms such as an acetyloxy group or an arylcarbonyloxy group such as a benzoyloxy group, which may be substituted with the group which may be substituted for the above cycloalkyl group.

The oxycarbonyl group represented by R¹-R¹⁵ includes an alkoxycarbonyl group such as a methoxycarbonyl group, an ethoxycarbonyl group, or a propyloxycarbonyl group, which may further be substituted. Listed as the preferred substituents may be those which may be substituted for the above cycloalkyl group.

The oxycarbonyloxy group represented by R¹-R¹⁵ includes an alkoxycarbonyloxy group such as a methoxycarbonyloxy group, which may further be substituted. Listed as the preferred substituents may be those which may be substituted for the above cycloalkyl group. Any two selected from R¹-R¹⁵ may be joined to form a ring structure.

It is possible to synthesize esters represented by Formula (1) employing methods known in the art. A representative synthetic example is shown in the examples. One method is in which the organic acid and polyhydric alcohol undergo etherification via condensation in the presence of, for example, acids, and another method is in which organic acid is converted to acid chloride or acid anhydride which is allowed to react with polyhydric alcohol, and still another method is in which the phenyl ester of organic acid is allowed to react with polyhydric alcohol. Depending on the targeted ester compound, it is preferable to select an appropriate method which results in a high yield.

The molecular weight of the polyhydric alcohol esters prepared as above is not particularly limited, but is preferably 300-1,500, but is more preferably 400-1,000. A greater molecular weight is preferred due to reduced volatility, while a smaller molecular weight is preferred in view of the resulting water vapor permeability and compatibility with cellulose ester.

Specific compounds of polyhydric alcohol esters according to the present invention will now be exemplified.

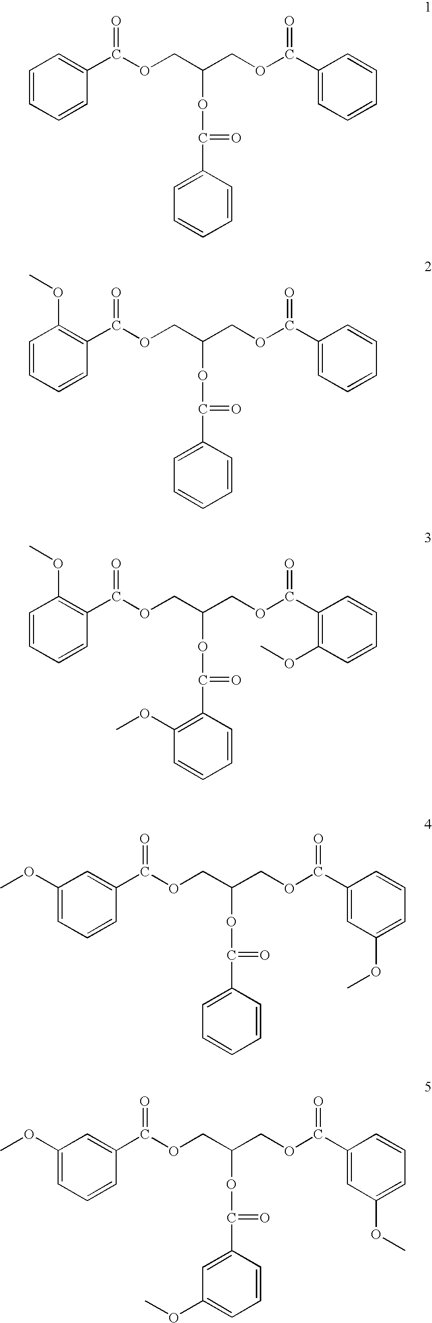

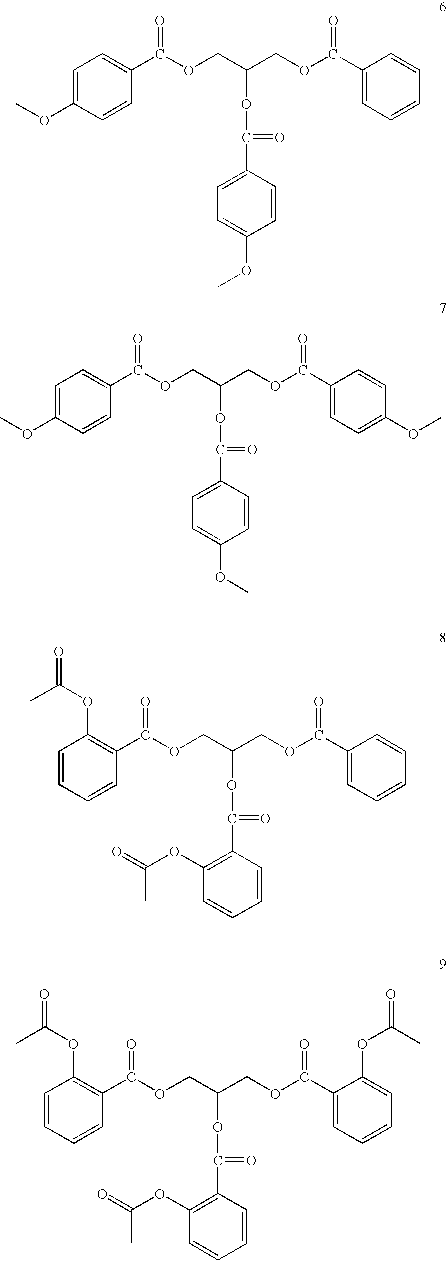

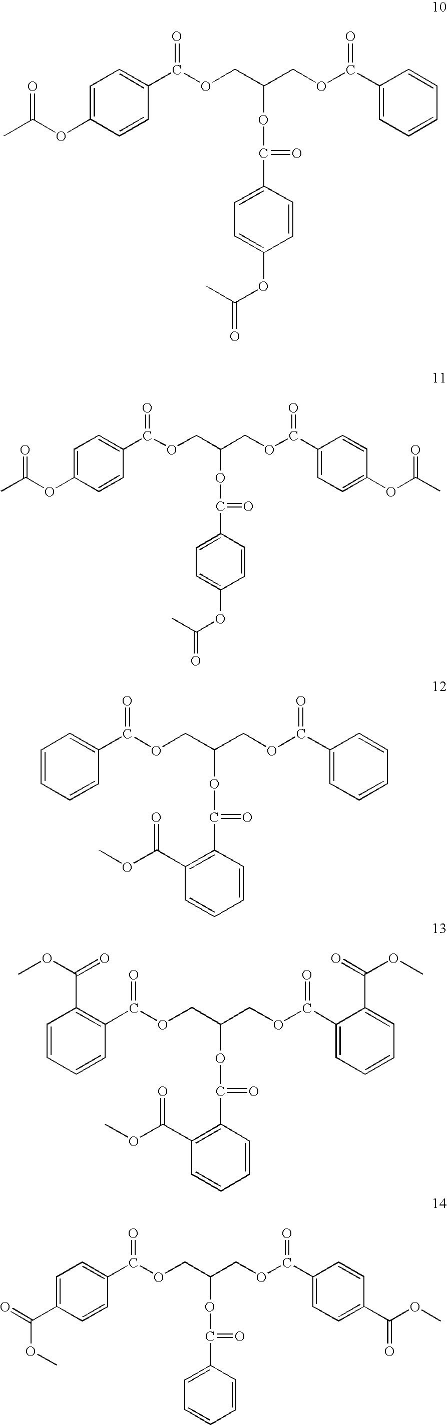

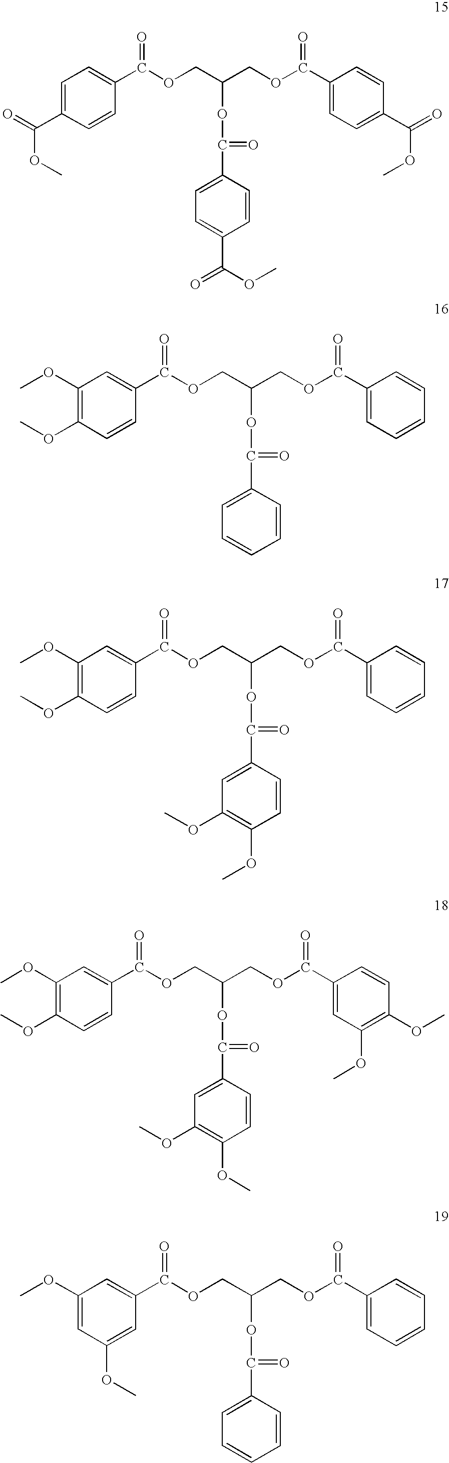

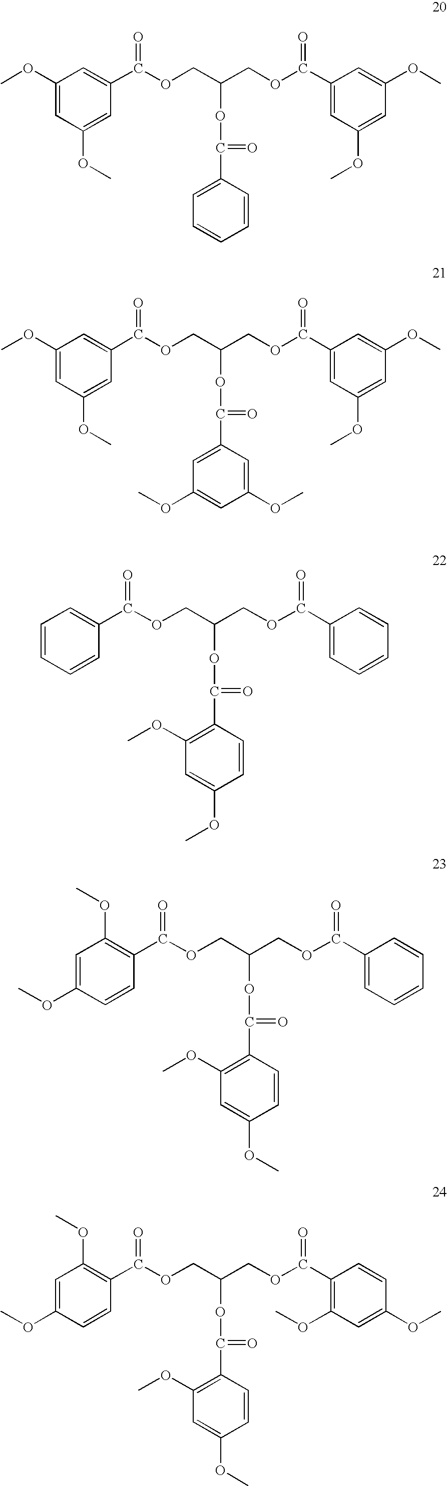

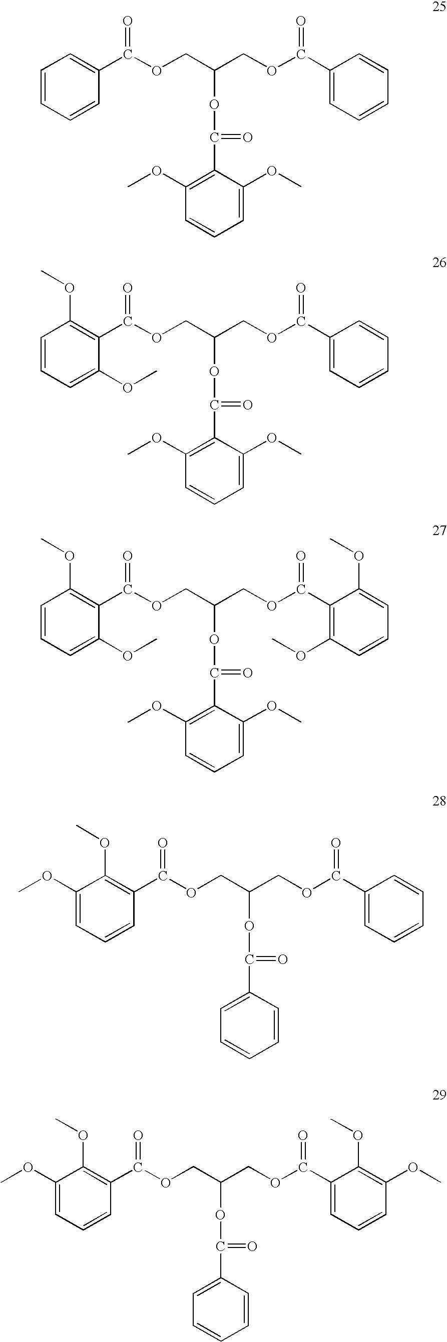

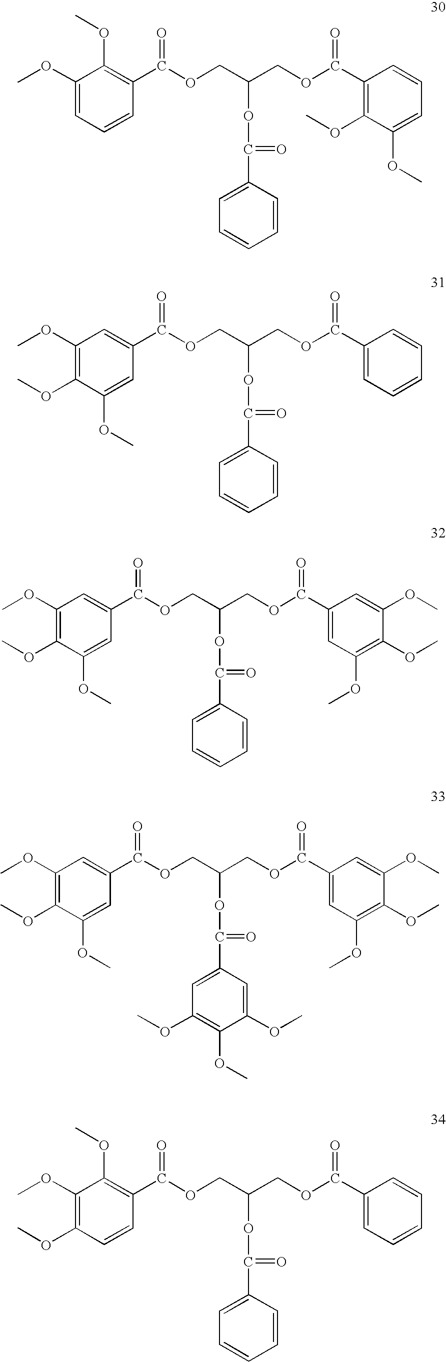

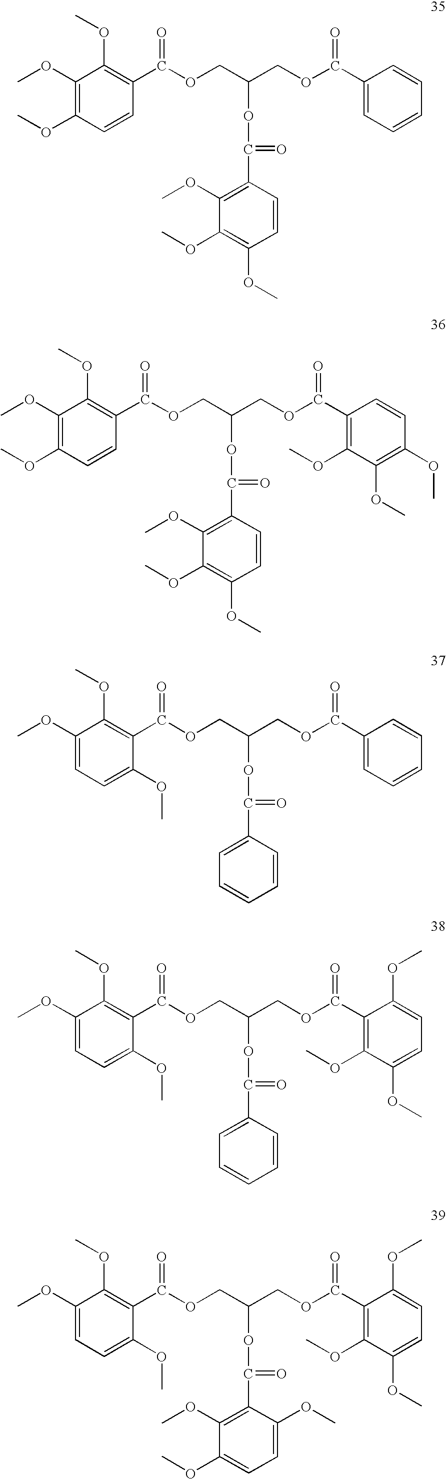

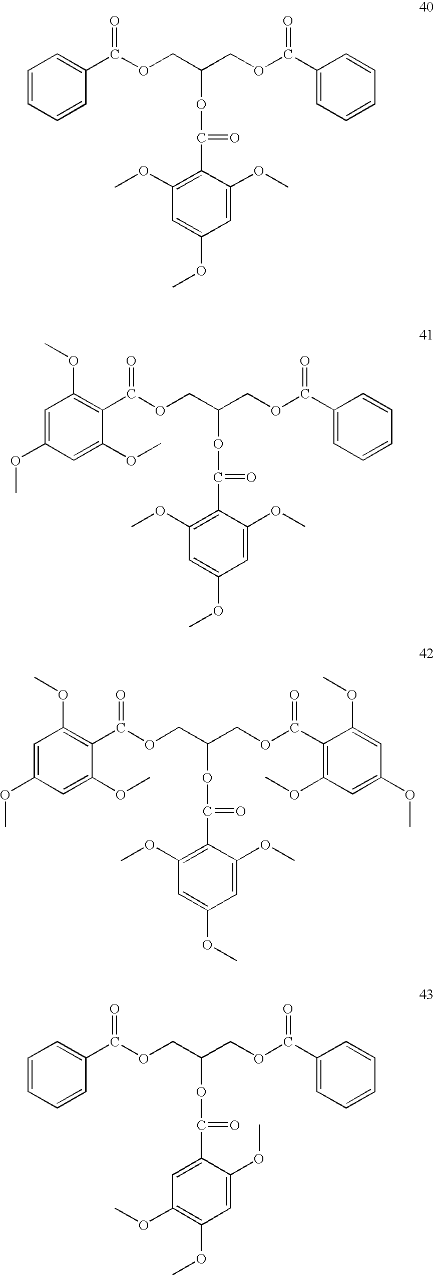

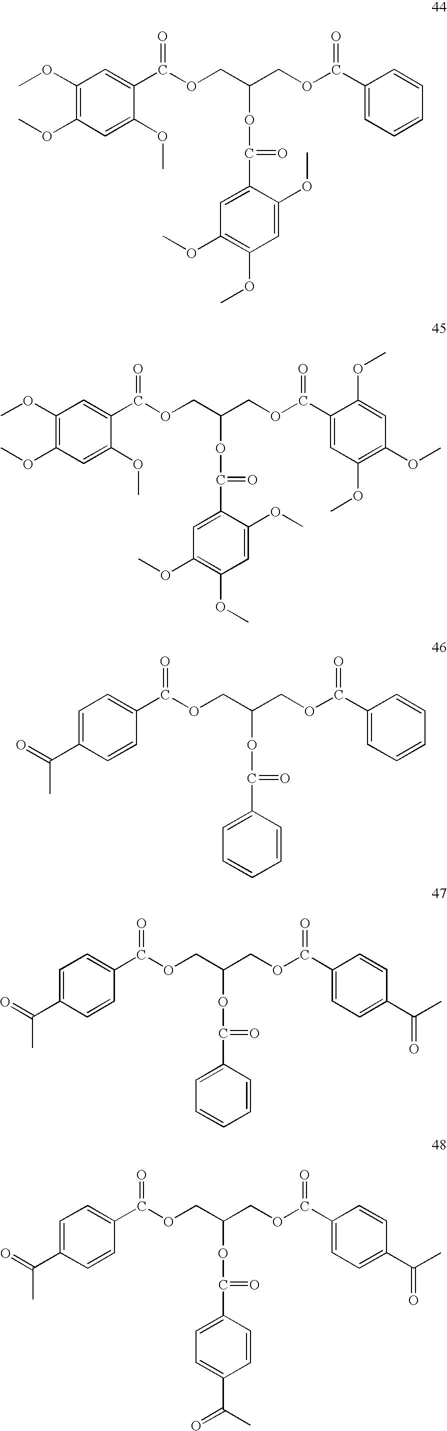

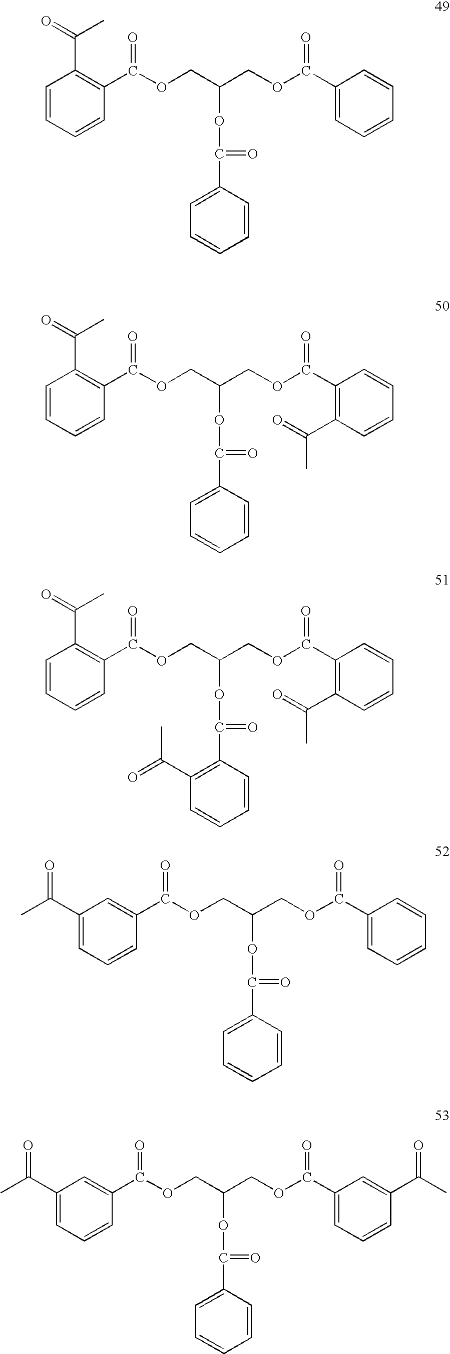

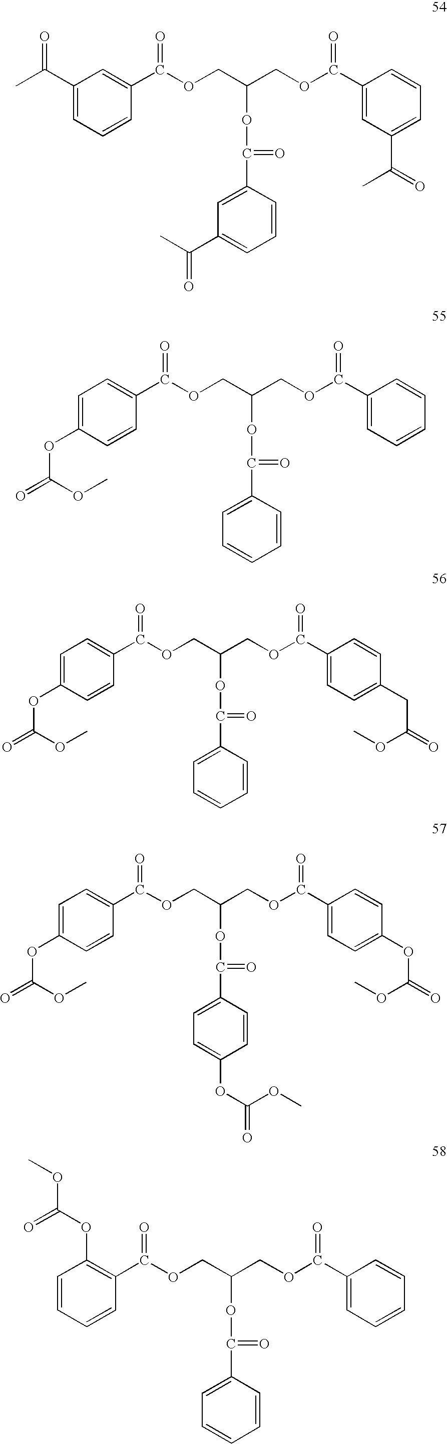

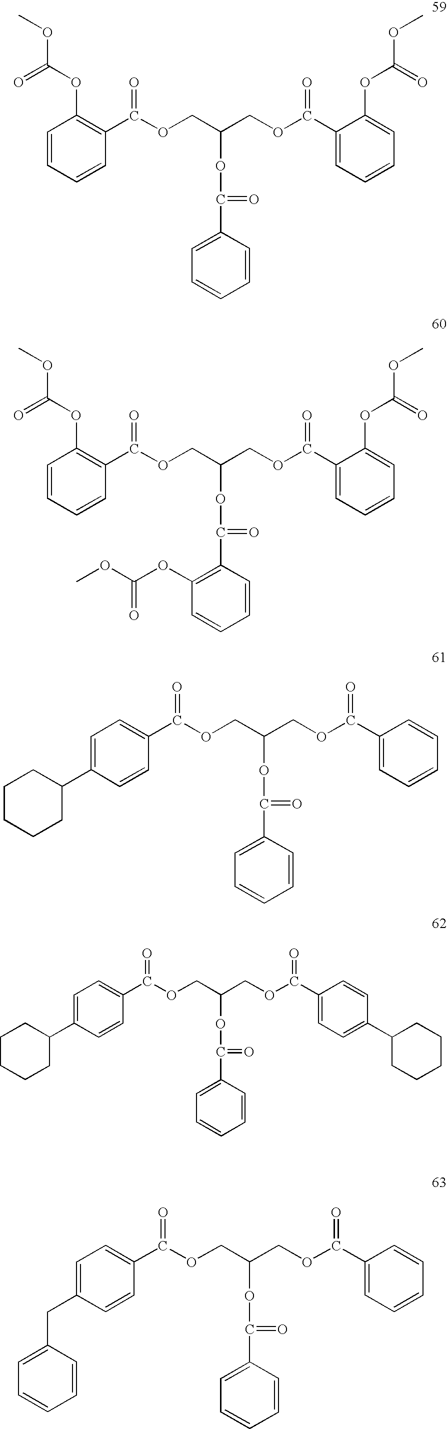

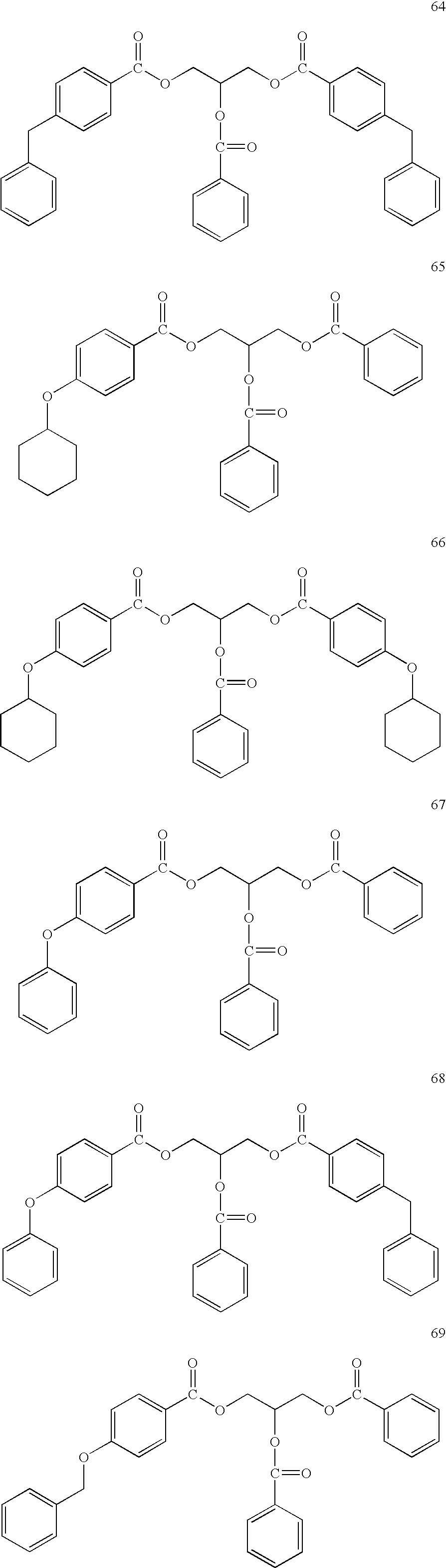

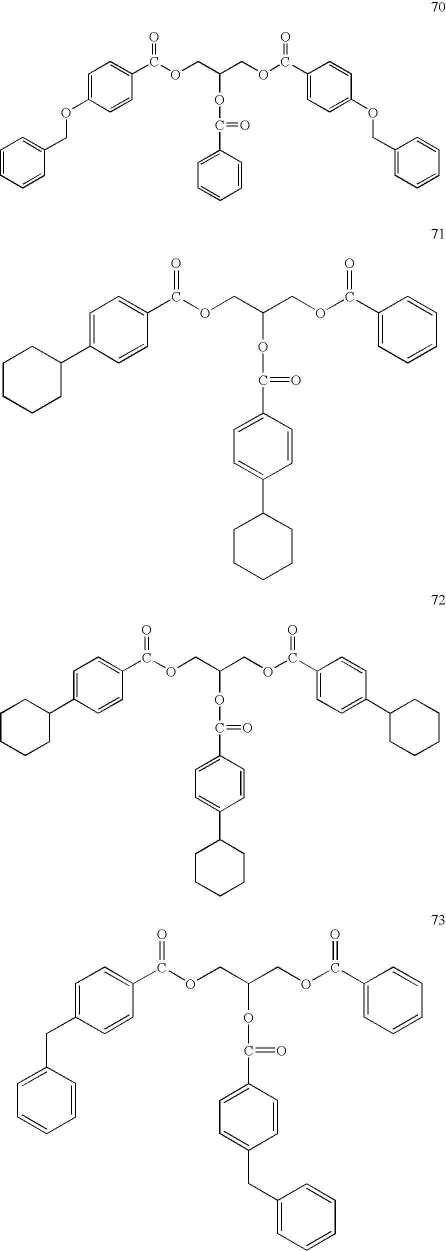

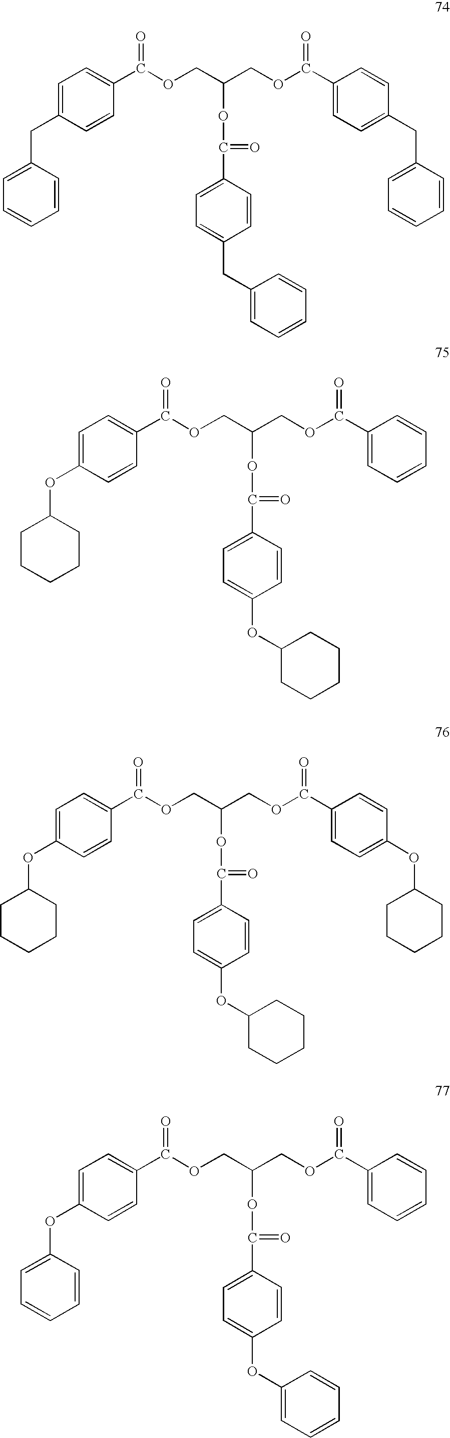

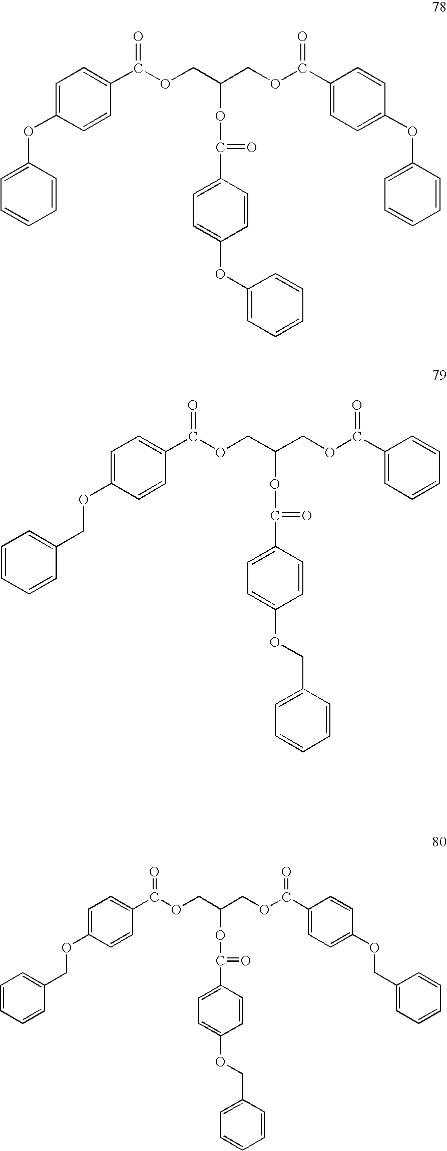

The cellulose acylate film employed in the present invention incorporates a plasticizer, at least one of the ester compounds which is represented by above Formula (1) according to the present invention. It may simultaneously incorporate plasticizers other than the above.

Ester compounds represented by above Formula (1), the plasticizers according to the present invention, exhibit the feature of being capable of adding at a high addition rate due to its high compatibility with cellulose ester. Consequently, no bleeding-out results by a combination of other plasticizers and additives, whereby, if desired, it is possible to simultaneously and easily employ other plasticizers and additives.

Further, when other plasticizers are simultaneously employed, the ratio of the incorporated plasticizers of the present invention is preferably at least 50 percent by weight with respect to the all the plasticizers, is more preferably at least 70 percent, and is still more preferably at least 80 percent. When the plasticizers of the present invention are employed in the above range, it is possible to achieve definite effects in which it is possible to enhance the flatness of cellulose ester film during melt-casting under simultaneous use of other plasticizers.

Other plasticizers which are simultaneously employed include aliphatic carboxylic acid-polyhydric alcohol based plasticizers, unsubstituted aromatic carboxylic acid or cycloalkylcaroboxylic acid-polyhydric alcohol based plasticizers described in paragraphs 30-33 of JP-A No. 2003-12823, or dioctyl adipate, dicyclohexyl adipate, diphenyl succinate, di-2-naphthyl-1,4-cyclohexane dicarboxylate, tricyclohexyl tricarbamate, tetra-3-methylphenyltetrahydrofurane-2,3,4,5-tetracarboxylate, tetrabutyl-1,2,3,4-cyclopentane teracarboxylate, triphenyl-1,3,5-cyclohexyl tricarboxylate, triphenylbenzne-1,3,5-etracarboxylate, multivalent carboxylates such as phthalic acid based plasticizers (for example, diethyl phthalate, dimethoxyethyl phthalate, dimethyl phthalate, dioctyl phthalate, dibutyl phthalate, di-2-ethylhexyl phthalate, dioctyl phthalate, dicyclohexyl phthalate, dicyclohexyl terephthalate, methylphthalyl methyl glycolate, ethylphthalyl ethyl glycolate, propylphthalyl propyl glycolate, and butylphthalyl butyl glycolate), citric acid based plasticizers (acetyltrimethyl citrate, acetyltriethyl citrate, and acetylbutyl citrate), phosphoric acid ester based plasticizers such as triphenyl phosphate, biphenyl diphenyl phosphate, butylenebis(diethyl phosphate), ethylenebis(diphenyl phosphate), phenylenebis(dibutyl phosphate), phenylenebis(diphenyl phosphate) (ADEKASTAB PFR, produced by Asahi Denka Kogyo K.K.), phenylenebis(dixylenyl phosphate) (ADEKASTAB FP500, produced by Asahi Denka Kogyo K.K.), bisphenol A diphenyl phosphate (ADEKASTAB FP600, produced by Asahi Denka Kogyo K.K.), and polyether based plasticizers such as the polymer polyesters described, for example, in paragraphs 49-56 of JP-A No. 2002-22956.

Of these, the use of phosphoric acid ester based plasticizers during melt-casting tends to result in undesired coloration. Consequently, it is preferable to employ phthalic acid ester based plasticizers, multivalent carboxylic acid ester based plasticizers, citric acid ester based plasticizers, polyester based plasticizers, and polyether based plasticizers.

Further, coloration of the cellulose ester film of the present invention results in adverse optical effects. Consequently, the degree of yellow (Yellow Index YI) is preferably at most 3.0, but is more preferably at most 1.0. It is possible to determine the Yellow Index value based on JIS K 7103.

(Cellulose Acylate)

A cellulose acylate employed in the present invention is detailed. In the present invention, the cellulose acylate constituting a film is preferably a cellulose acylate having an aliphatic acyl group having a number of carbon of 2 or more, and more preferably a cellulose acylate having a total substitution degree of acyl groups of 2.95 or less, and an acyl group total carbon number of from 6.2 to 7.5. The acyl group total carbon number of the cellulose acylate is preferably from 6.5 to 7.2, and more preferably from 6.7 to 7.1. The term “acyl group total carbon number” means that the sum of the products of the substitution degree of each acyl group substituted into a glucose unit in the cellulose acylate and the number of carbons. Further, the carbon number of an aliphatic acyl group is, from views of productivity and a production cost of the cellulose synthesis, preferably from 2 to 6, and more preferably from 2 to 4. Positions not substituted with an acyl group usually exist as a hydroxyl group. These can be synthesized via commonly known methods.

The glucose unit constituting the cellulose with a β-1,4-glycoside bonding has free hydroxyl groups at the 2, 3 and 6-positions The cellulose acylate of the present invention is a polymerization product (polymer) in which a part or all of the above hydroxyl groups are esterified with acyl groups. The term “substitution degree” indicates the sum of the ratios at which the cellulose is esterified at 2, 3 and 6-positions of the repeating unit. Specifically, in a case where hydroxyl groups at each of 2, 3 and 6-positions of cellulose are esterified by 100%, the substitution degree at each position is 1. Accordingly, in a case where all of the hydroxyl groups at 2, 3 and 6-positions of cellulose are esterified by 100%, the substitution degree is 3 at maximum.

Examples of the acyl group include an acetyl group, a propionyl group, a butyryl group, a pentanate group, and hexanate group, and examples of cellulose acylate include a cellulose propionate, a cellulose butylate, and a cellulose pentanate. Moreover, as long as the above-mentioned side chain carbon number is satisfied, a mixed fatty acid ester such as a cellulose acetate propionate, a cellulose acetate butylate, and a cellulose acetate pentanate may be employed. Of these, in particular, a cellulose acetate propionate and a cellulose acetate butylate are preferable.

The inventors of the present invention have grasped that there exist a trade-off between the mechanical physical and saponification properties of the cellulose acylate film and the melt film formation properties of the cellulose acylate with regard to the acyl group total carbon number of the cellulose acylate. For example, in the cellulose acetate propionate, an increase in the total number of carbon atoms contained in the acyl group improves the melt film formation properties, but decreases the mechanical properties, and thus, compatibility is difficult to achieve. However, inventors found that, in the present invention, compatibility among the film mechanical physical properties, saponification properties and melt film formation properties can be ensured by setting the total substitution degree of the acyl group in the cellulose acylate to be 2.9 or less, and an acyl group total carbon number to be from 6.5 to 7.2. Although the details of the mechanism are not very clear, it is assumed that the number of carbon atoms contained in the acyl group has a differing effect on each of the film mechanical physical properties, saponification properties, and melt film formation properties. More specifically, a longer-chained acyl group such as a propionyl group, and a butyryl group, rather than the acetyl group, provides a higher degree of hydrophobicity, provided that the total substitution degree of the acyl group of the above groups are the same, to result in improved melt film formation properties. Thus, it is assumed that, in a case where the same level of melt film formation properties are achieved, the substitution degree of the long-chained acyl group such as a propionyl group, and a butyryl group is lowered than that of the acetyl group, and the total substitution degree is also lowered, whereby reduction in the mechanical physical properties and saponification properties is suppressed.

The ratio of weight average molecular weight, Mw/number average molecular weight Mn, of cellulose acylates employed in the present invention is commonly 1.0-5.5, is preferably 1.4-5.0, but is most preferably 2.0-3.0. Further, Mw of the used cellulose esters is commonly 100,000-500,000 but is preferably 150,000-300,000.

It is possible to determine the average molecular weight and molecular weight distribution of cellulose acylates employing the methods known in the art which employ high speed liquid chromatography.

Measurement conditions for the above are as follows.
Solvent: methylene chlorine
Column: SHODEX KS806, KS805, and K803 (produced by Showa Denko K.K., these columns were used upon being connected)
Column temperature: 25° C.
Sample concentration: 0.1 percent by weight
Detector: RI Model 504 (produced by GL Science Co.)
Pump: L6000 (produced by Hitachi, Ltd.)
Flow rate: 1.0 ml/minute
Calibration curve: The used calibration curve was prepared employing 13 samples of Standard Polystyrene STK, polystyrene (produced by Tosoh Corp.) of 500-1,000,000 Mw. It is preferable that the above 13 samples are selected to result in approximately equal intervals.

Raw cellulose materials of the cellulose esters employed in the present invention may be either wood pulp or cotton linter. Wood pulp may be made from either conifers or broad-leaved trees, but coniferous pulp is more preferred. However, in view of peeling properties during casting, cotton linters are preferably employed. Celluloses esters prepared employing these materials may be employed individually or in appropriate combinations.

For example, the following ratios are possible: cellulose ester derived from cotton linter:cellulose ester derived from wood pulp (conifers):cellulose ester derived from wood pulp (broad-leaved trees) is 100:0:0, 90:10:0, 85:15:0, 50:50:0, 20:80:0, 10:90:0, 0:100:0, 0:0:100, 80:10:10, 85:0:15, and 40:30:30.

It is possible to prepare cellulose esters by replacing the hydroxyl group of cellulose raw materials with an acetyl group, an propionyl group, and/or a butyl group, employing acetic anhydride, propionic anhydride, and/or butyric anhydride based on conventional methods. Synthesis methods of such cellulose esters are not particularly limited, and it is possible to synthesize them with reference to, for example, JP-A No. 10-45804 or JP-A (under PCT Application) No. 6-501040.

It is possible to determine the degree of substitution of the acetyl group, propionyl group, and butyl group based on ASTM-D817-96.

Further, cellulose esters are industrially synthesized employing sulfuric acid as a catalyst, however the above sulfuric acid is not easily completely removed. The residual sulfuric acid undergoes various types of decomposition reactions to result in adverse effects to product quality of the resulting cellulose ester films Consequently, it is desirable to control the residual sulfuric acid in the cellulose esters employed in the present invention within the range of 0.1-40 ppm in terms of sulfur element. It is assumed that these acids are incorporated in the form of salts. It is not preferable that the content of the residual sulfuric acid exceeds 40 ppm, because adhering materials on die lips increase during heat melting. Further, it is preferable that the content is relatively small. However, it is not preferable that content is at most 0.1, because achieving at most 0.1 results in excessively large load for the washing process of cellulose resins and further on the contrary, breakage tends to occur during or after heat stretching. It is assumed that an increase in washing frequency adversely affects the resins, but the reasons for this are not well understood. The content of the residual sulfuric acid is more preferably in the range of 0.1-30 ppm. It is also possible to determine the content of the residual sulfuric acid based on ASTM-D817-96.

The total amount of residual acids (such as acetic acid or others) is preferably less than 1000 ppm.

By further sufficiently washing synthesized cellulose compared to the case in which the solution-casting method is employed, it is possible to achieve the desired content of residual sulfuric acid to be within the above range. Thus, during production of film employing the melt-casting method, adhesion to the lip portions is reduced to produce films of excellent flatness, whereby it is possible to produce films which exhibit excellent dimensional stability, mechanical strength, transparency, and water vapor transmitting resistance, as well as the desired Rt and Ro values described below.

Still further, it is preferable that when the cellulose esters employed in the present invention are converted to a film, the resulting film produces minimal foreign matter bright spots. “Foreign matter bright spots” refers to the following type of spots. A cellulose ester film is placed between two polarizing plates arranged at right angles (crossed Nicols) and light is exposed on one side while the other side is viewed. When foreign matter is present, light leaks through the film and a phenomenon occurs in which foreign matter particles are seen as bright spots. During this operation, the polarizing plate, which is employed for evaluation, is composed of a protective film without any foreign matter bright spots, whereby a glass plate is preferably employed to protect polarizers. It is assumed that one of the causes of foreign matter bright spots is the presence of cellulose which has undergone no acetylation or only a low degree of acetylation. It is necessary to employ cellulose esters (or employing cellulose esters exhibiting a degree of uniform substitution). Further, it is possible to remove foreign matter bright spots in such a manner that melted cellulose esters are filtered, or during either the latter half of the synthesis process of the cellulose esters, or during the process to form precipitates, a solution is temporarily prepared and is filtered via a filtration process. Since melted resins exhibit high viscosity, the latter method is more efficient.

It is likely that as the film thickness decreases, the number of foreign matter bright spots per unit area decreases, and similarly, as the content of cellulose ester incorporated in films decreases, foreign matter bright spots decreases. The number of at least 0.01 mm foreign matter bright spots is preferably at most 200/cm², is more preferably at most 100/cm², is still more preferably at most 50/cm², is still more preferably at most 30/cm², is yet more preferably at most 10/cm², but is most preferably of course zero. The number of foreign matter bright spots having diameters of 0.005 to 0.01 mm is preferably less than 100/cm², more preferably it is less than 50/cm², and still more preferably less than 30/cm², but is most preferably of course zero.

In cases in which bright spot foreign matter is removed via melt-filtration, it is preferable to filter the melted composition composed of cellulose esters, plasticizers, degradation resistant agents, and antioxidants, rather than to filter melted individual cellulose ester, whereby bright spot foreign matter is efficiently removed. Of course, bright spot foreign matter may be reduced in such a manner that during synthesis of cellulose ester, the resulting cellulose ester is dissolved in solvents and then filtered. It is possible to filter compositions which appropriately incorporate UV absorbers and other additives. The viscosity of the melt, incorporating cellulose esters, which is to be filtered, is preferably at most 10,000 Pa·s, is more preferably at most 9,000 Pa·s, is still more preferably at most 1,000 Pa·s, but is most preferably at most 500 Pa·s. Preferably employed as filters are those known in the art, such as glass fibers, cellulose fibers, paper filters, or fluorine resins such as tetrafluoroethylene. However, ceramic and metal filters are particularly preferably employed. The absolute filtrations accuracy of employed filters is preferably at most 50 μm, is more preferably at most 30 μm, is still more preferably at most 10 μm, but is most preferably at most 5 μm. It is possible to employ them in suitable combinations. Employed as a filter, may be either a surface type or a depth type. The depth type is more preferably employed since it is relatively more free from clogging.

In another embodiment, employed as raw cellulose ester materials may be those which are dissolved in solvents at least ounce, and then dried to remove the solvents. In this case, cellulose ester is dissolved in solvents together with at least one of a plasticizer, an UV absorber, a degradation resistant agent, an antioxidant, and a matting agent, Thereafter, the mixture is dried and then used as a cellulose ester composition. Employed as solvents may be good solvents, such as methylene chloride, methyl acetate, dioxolan, which are employed in the solution-casting method, while poor solvents such as methanol, ethanol, or butanol may also be simultaneously employed. In the dissolving process, cooling may be performed to −20° C. or lower, or heated to 80° C. or higher. By employing such cellulose ester, it is possible to uniformly mix each of the additives in a melted state and, it is occasionally possible to make the resulting optical characteristic very uniform.

The cellulose acylate film of the present invention may be one which is formed by suitably blending polymer components other than cellulose esters. Polymers to be blended are preferably those which are highly compatible with cellulose esters. When converted to a film, the resulting transmittance is preferably at least 80 percent, is more preferable at least 90 percent, but is still more preferably 92 percents.

### (Other Additives)

Other than cellulose esters and plasticizers, in the cellulose acylate film of the present invention incorporated may be various functional additives such as stabilizers, lubricants, matting agents, fillers, inorganic polymers, organic polymers, dyes, pigments, phosphors, UV absorbers, infrared ray absorbers, diachronic dyes, refractive index controlling agents, retardation controlling agents, gas transmission retarding agents, antimicrobial agents, electric conductivity enhancing agents, biodegradability enhancing agents, gelatin inhibitors, or thickeners.

The cellulose esters of the present invention are melt-cast at a relatively high temperature such as 200-250° C., whereby in the process, decomposition and degradation of cellulose esters tend to occur compared to conventional solution-casting film production. Consequently, it is preferable that of the above additives, especially stabilizers are incorporated into film forming materials.

Examples of stabilizers include, but are not limited to, antioxidants, acid scavengers, hindered amine light stabilizers, UV absorbers, peroxide decomposing agents, radical scavengers, and metal inactivating agents. These are described in JP-A Nos. 3-199201, 5-1907073, 5-194789, 5-371471, and 6-107854. It is preferable that at least one which is selected from those is incorporated in the film forming materials.

Further, when the cellulose acylate film of the present invention is employed as a polarizer protecting film or a retardation film, the polarizer is easily degraded by ultraviolet radiation. Consequently, it is preferable that UV absorbers are incorporated into at least the light incident side of the polarizer.

Further, when the cellulose acylate film of the present invention is employed as a retardation film, it is possible to incorporate additives to control the retardation. Employed as additives to control retardation may be the retardation controlling agents described in European Patent No. 911,656A2.

Still further, in order to control the viscosity during heat-melt and to regulate physical film properties after film treatment, it is possible to add organic or inorganic polymers to the cellulose acylate film.

During addition of these additives to cellulose ester resins, the total amount including the above additives is 1-30 percent by weight with respect to the weight of cellulose ester resins. When the amount is at most one percent by weight, melt-casting properties are degraded, while when it exceeds 30 percent by weight, it is not possible to achieve desired dynamic characteristics nor desired storage stability.

### (Antioxidants)

Since decomposition of cellulose esters is accelerated not only by heat but also by oxygen at the high temperature at which melt-casting is performed, it is preferable that antioxidants are incorporated as a stabilizer into the cellulose acylate film of the present invention.

Antioxidants which are used as a useful antioxidant in the present invention are not particularly limited as long as they are compounds which retard degradation of melt-molded materials via the presence of oxygen. Useful antioxidants include hindered phenol based antioxidants, hindered amine based antioxidants, phosphorous based antioxidants, sulfur based antioxidants, heat resistant process stabilizing agents, and oxygen scavengers. Of these, particularly preferred are hindered phenol based antioxidants, hindered amine based antioxidants and phosphorous based antioxidants.

By blending these antioxidants, it is possible to minimize coloration and strength degradation of molded products due to heat, as well as thermal oxidation degradation during melt molding. These antioxidants may be employed individually or in combinations of at least two types.

Of the above antioxidants, preferred are hindered phenol based antioxidants. The hindered phenol based antioxidants are prior art compounds, which are described, for example, in column 12-14 of U.S. Pat. No. 4,839,405, including 2,6-dialkyl phenol derivatives. Of such compounds, included as preferable compounds are those represented by Formula (2) below.

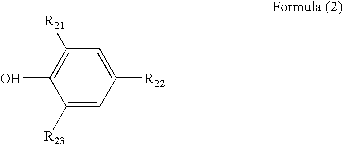

In the Formula, R₂₁, R₂₂ and R₂₃ each represent a substituted or unsubstituted alkyl substituent. Specific examples of hindered phenol compounds include n-octadecyl 3-3,5-di-t-butyl-4-hydroxyphenyl)-propionate, n-octadecyl 3-3,5-di-t-butyl-4-hydroxyphenyl)-acetate, n-octadecyl 3,5-di-t-butyl-4-hydroxybenzoate, n-hexyl 3,5-di-t-butyl-4-hydroxyphenylbenzoate, n-dodecyl 3,5-di-t-butyl-4-hydroxyphenyl benzoate, neo-dodecyl 3-(3,5-di-t-butyl-4-hydroxyphenyl)propionate, dodecyl β(3,5-di-t-butyl-4-hydroxyphenyl)propionate, ethyl α-(4-hydroxy-3,5-di-t-butylphenyl)isobutyrate, octadecyl α-(4-hydroxy-3,5-di-t-butylphenyl)isobutyrate, octadecyl α-(4-hydroxy-3,5-di-t-butyl-4-hydroxyphenyl)propionate, 2-n-octylthio)ethyl 3,5-di-t-butyl-4-hydroxy-benzoate, 2-(n-octylthio)ethyl 3,5-di-t-butyl-4-hydroxy-phenyl acetate, 2-(n-octadecylthio)ethyl 3,5-di-t-butyl-4-hydroxyphenyl acetate, 2-(n-octadecylthio)ethyl 3,5-di-t-butyl-4-hydroxy-benzoate, 2-(2-hydroxyethylthio)ethyl 3,5-di-t-butyl-4-hydroxybenzoate, diethylglycolbis-(3,5-di-t-butyl-4-hydroxyphenyl) propionate, 2-(n-octadecythio)ethyl 3-(3,5-di-t-butyl-4-hydroxyphenyl) propionate, stearylamido N,N-bis-[ethylene 3-(3,5-di-t-butyl-4-hydroxyphenyl)propionate], n-butylimino N,N-bis-[ethylene 3-(3,5-di-t-butyl-4-hydroxyphenyl)propionate], 2-(2-stearoyloxyethylthio)ethyl 3,5-di-t-butyl-4-hydroxybenzoace, 2-(2-stearoyloxyethylthio)ethyl 7-(3-methyl-5-t-butyl-4-hydroxyphenyl) heptanoate, 1,2-propyleneglycolbis-[3-(3,5-di-t-butyl-4-hydroxyphenyl)propionate], ethyleneglycolbis-[3-(3,5-di-t-butyl-4-hydroxyphenyl) propionate], neopentylglycolbis-[3-(3,5-di-t-butyl-4-hydroxyphenyl) propionate], ethyleneglyxolbis-(3,5-di-t-butyl-4-hydroxyphenyl acetate), glycerin-1-n-octadecanoate-2,3-bis-(3,5-di-t-butyl-4-hydroxyphenyl acetate), pentaerythritol-tetrakis-[3-(3′,5′-di-t-butyl-4′-hydroxyphenyl) propionate], 1,1,1-trimethylolethane-tris-[3-(3,5-di-t-butyl-4-hydroxyphenyl) propionate], sorbitolhexa-[3-(3,5-di-t-butyl-4-hydroxyphenyl) propionate], 2-hydroxyethyl 7-(3-methyl-5-t-butyl-4-hydroxyphenyl) propionate, 2-stearoyloxyethyl 7-(3-methyl-5-t-butyl-4-hydroxyphenyl) heptanoate, 1,6-n-hexanediol-bis[(3′,5′-di-t-butyl-4-hydroxyphenyl) propionate], and pentaerythritol-tetrakis(3,5-di-t-butyl-4-hydroxyhydrocinnamate). The above type hindered phenol compounds are commercially available under trade names such as “IRGANOX 1076” or “IRGANOX 1010” from Ciba Specialty Chemicals.

Phosphorous antioxidants are commonly known compounds, and preferable compounds include, for exampler compounds represented by Formula (1) in JP-A No. 2002-138188, compounds represented by Formulae (2) to (4) in JP-A No. 2004-182979, and compounds represented by Formula (4) in JP-A No. 2005-344044. Specific compounds include compounds represented by Formulae (5) to (8), and (9) to (11), or tetrakis(2,4-di-tert-butylphenyl) [1,1-biphenyl]-4,4′-diylbisphosphonite, tetrakis(2,6-di-tert-butylphenyl)[1,1-biphenyl]-4,4′-diylbisphosphonite, tetrakis(2,6-di-tert-butylphenyl-4-methyl)[1,1-biphenyl]-4,41-diylbisphosphonite, bis(2,6-di-tert-butyl-4-methylphenyl)pentaerythritol diphosphite, bis(2-tert-butyl-4-cumylphenyl)pentaerythritol diphosphite, bis(4-tert-butyl-2-cumylphenyl)pentaerythritol diphosphite, bis(2,6-di-tert-butyl-4-ethylphenyl)pentaerythritol diphosphite, and bis(2,4-di-tert-butyl-G methylphenyl)pentaerythritol diphosphite. In addition, included are compounds described in each Patent Document of JP-A Nos. 10-306175, 1-254744, 2-270892, 5-202078, 5-178870, and 2004-504435.

Also, as commercially available compounds, SUMILIZER GP (produced by Sumitomo Chemical Co., Ltd.), REP-36 (produced by ADEKA Corp.), and GSY-P101 (produced by API Corp.) are listed.

The addition amount of antioxidants is preferably 0.1-10 percent by weight, is more preferably 0.2-5 percent by weight, but is still more preferably 0.5-2 percent by weight. These may be employed in combinations of at least two types.

### (Acid Scavengers)

At the relatively high temperature at which melt-casting is performed, decomposition of cellulose esters is also accelerated by the presence of acids, whereby it is preferable that the cellulose acylate film of the present invention incorporates acid scavengers as a stabilizer. Acid scavengers in the present invention may be employed without any limitation, as long as they are compounds which react with acids to inactivate them. Of such compounds, preferred are compounds having an epoxy group, as described in U.S. Pat. No. 4,137,201. Epoxy compounds as such an acid scavenger are known in this technical field, and include diglycidyl ethers of various polyglycols, especially, polyglycols which are derived by condensation of ethylene oxides in an amount of about 8 about 40 mol per mol of polyglycol, metal epoxy compounds (for example, those which have conventionally been employed together with vinyl chloride polymer compositions in vinyl chloride polymer compositions), epoxidized ether condensation products, diglycidyl ethers (namely, 4,4′-dihydroxydiphenyldimethylmethane) of bisphenol A, epoxidized unsaturated fatty acid esters (particularly, alkyl esters (for example, butyl epoxystearate) having about 2-about 4 carbon atoms of fat acids having 2-22 carbon atoms) epoxidized plant oils which can be represented and exemplified by compositions of various epoxidized long chain fatty acid triglycerides (for example, epoxidized soybean oil and epoxidized linseed oil and other unsaturated natural oils (these are occasionally called epoxidized natural glycerides or unsaturated fatty acid and these fatty acid have 12-22 carbon atoms). Further, preferably employed as commercially available epoxy group incorporating epoxide resinous compounds may be EPON 815C and other epoxidized ether oligomer condensation products represented by Formula (3).

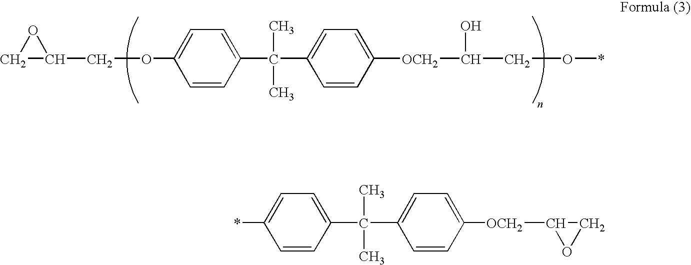

In Formula, n represent an integer of 0-12. Other usable acid scavengers include those described in paragraphs 87-105 of JP-A No. 5-194788.

The added amount of acid scavengers is preferably 0.1-10 percent by weight, is more preferably 0.2-5 percent by weight, but is still more preferably 0.5-2 percent by weight. These may be employed in combinations of at least two types.

Further, acid scavengers may also be called acid catchers or other names, but in the present invention, it is possible to use them regardless name.

(Carbon Radical Scavenger)

It is preferable that the cellulose acylate film of the present invention incorporates a carbon radical scavenger as a heat-resistant processing stabilizer under high temperature environment where a melt film formation is carried out.

The term “carbon radical scavenger” used in the present invention refers to a compound having a group (for example, an unsaturated group such as a double bond or a triple bond) capable of promptly performing an addition reaction with carbon radicals, while providing a stable compound which does not cause a subsequent reaction such as polymerization after the compound reacted with carbon radicals. As the carbon radical scavenger, usable are compounds having a radical polymerization prohibition function in their molecules, such as a group which promptly reacts with carbon radicals (for example, unsaturated groups such as a (meth)acryloyl group or an aryl group), and a phenol compound or a lactone compound. Of these, in particular, a compound which is represented by Formula (4) or (5) below is preferable.

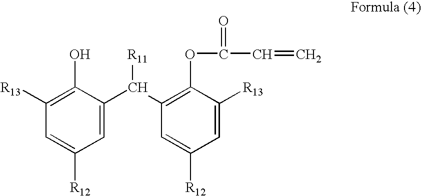

In Formula (4), R₁₁ represents a hydrogen atom or an alkyl group having a carbon atom number of 1 to 10, preferably a hydrogen atom or an alkyl group having a carbon atom number of 1 to 4, and particularly preferably a hydrogen atom or a methyl group. Each of R₁₂ and R₁₃ independently represents an alkyl group having a carbon atom number of 1 to 8, provided that the alkyl may be a straight chain or may have a branched or cyclic structure. R₁₂ and R₁₃ preferably have a structure represented by “1*—C(CH₃)₂—R′” containing a quaternary carbon (wherein * indicates a linkage position to an aromatic ring, and R′ represents an alkyl group having a carbon atom number of 1 to 5). R₁₂ is preferably a tert-butyl group, a tert-amyl group, or a tert-octyl group. R₁₃ is preferably a tert-butyl group, or a tert-amyl group. As commercially available compounds represented by the above Formula (4), SUMILIZER GM and SUMILAIZER GS (both of which are trade names and produced by Sumitomo Chemical Co., Ltd.) are listed.

Specific examples (I-1 to I-18) of a compound represented by the above Formula (4) are illustrated below, but the present invention is not limited to them.

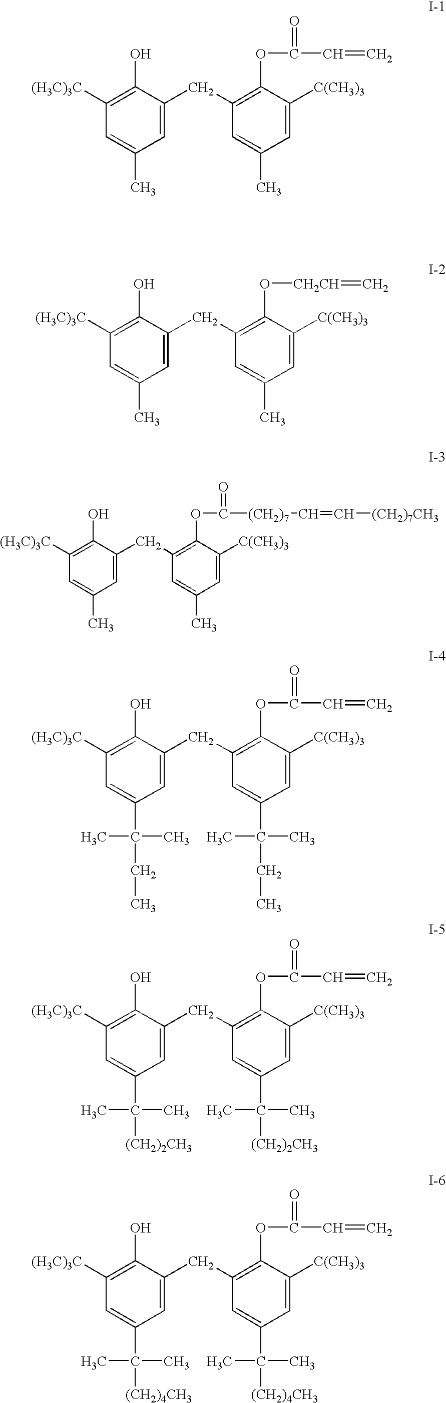

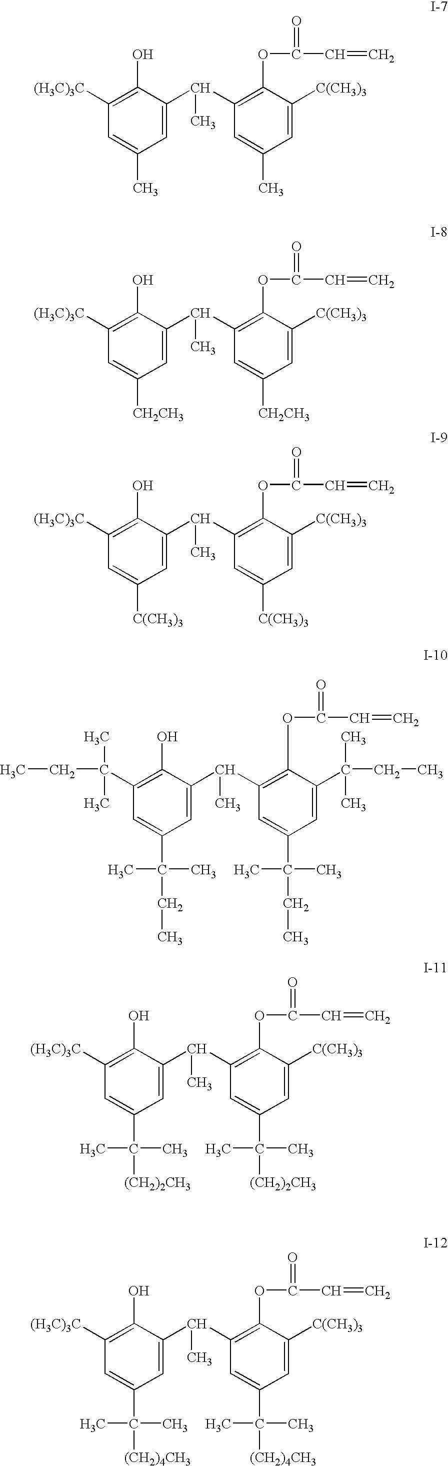

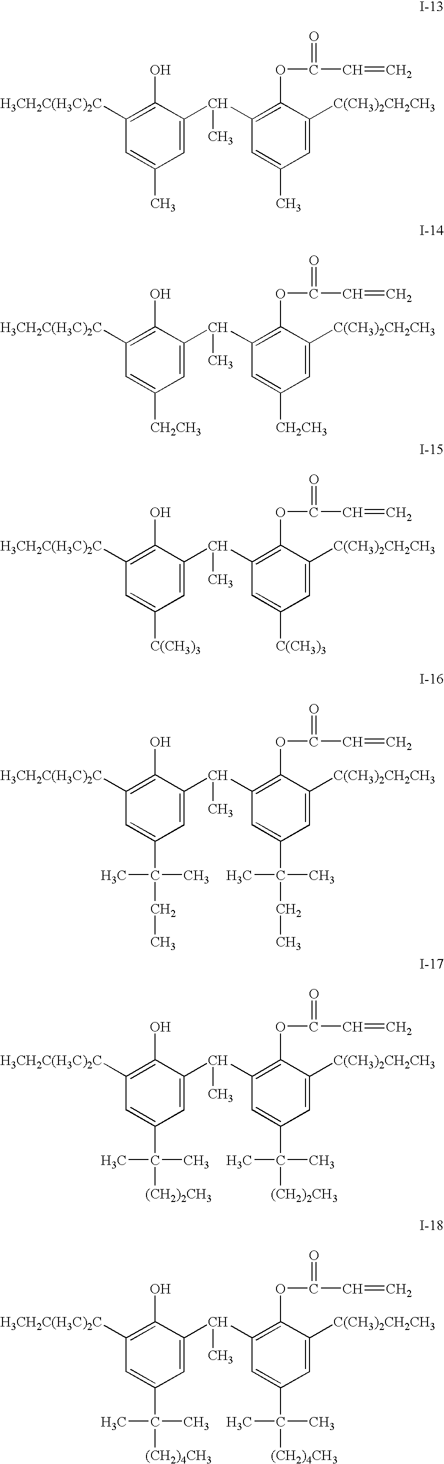

Compounds represented by Formula (5) will now be explained.

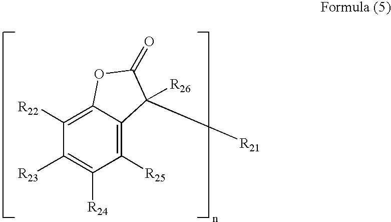

In the above Formula (5), each of R₂₂ to R₂₅ independently represents a hydrogen atom or a substituent, and examples of a substituent represented by R₂₂ to R₂₅ include, but not particularly limited, an alkyl group (for example, a methyl group, an ethyl group, a propyl group, an isopropyl group, a t-butyl group, a pentyl group, a hexyl group, an octyl group, a dodecyl group, or a trifluoromethyl group), a cycloalkyl group (for example, a cyclopentyl group or a cyclohexyl group), an aryl group (for example, a phenyl group, or a naphthyl group), an acylamino group (for example, an acetylamino group, or a benzoyl amino group), an alkylthio group (for example, a methylthio group, or an ethylthio group), an arylthio group (for example, a phenylthio group or a naphthylthio group), an alkenyl group (for example, a vinyl group, a 2-propenyl group, a 3-butenyl group, a 1-methyl-3-propenyl group, a 3-pentenyl group, a 1-methyl-3-butenyl group, a 4-hexenyl group or a cyclohexenyl group), a halogen atom (for example, fluorine, chlorine, bromine, or iodine), an alkinyl group (for example, a propargyl group), a heterocyclic group (for example, a pyridyl group, a thiazolyl group, an oxazolyl group, or an imidazolyl group), an alkylsulfonyl group (for example, a methyl sulfonyl group or an ethyl sulfonyl group), an aryl sulfonyl group (for example, a phenyl sulfonyl group or a naphthyl sulfonyl group), a alkyl sulfinyl group (for example, a methyl sulfinyl group), an aryl sulfonyl group (for example, a phenyl sulfinyl group), a phosphono group, an acyl group (for example, an acetyl group, a pivaloyl group or a benzoyl group), a carbamoyl group (for example, an amino carbonyl group, a methyl amino carbonyl group, a dimethyl amino carbonyl group, a butyl amino carbonyl group, a cyclohexyl amino carbonyl group, a phenyl amino carbonyl group, or a 2-pyridyl amino carbonyl group), a sulfamoyl group (for example, an amino sulfonyl group, a methyl amino sulfonyl group, a dimethyl amino sulfonyl group, a butyl amino sulfonyl group, a hexyl amino sulfonyl group, a cyclohexyl amino sulfonyl group, an octyl amino sulfonyl group, a dodecyl amino sulfonyl group, a phenyl amino sulfonyl group, a naphthyl amino sulfonyl group or a 2-pyridyl amino sulfonyl group), a sulfonamide group (for example, a methane sulfonamide group or a benzene sulfonamide group), a cyano group, an alkoxy group (for example, a methoxy group, an ethoxy group, or a propoxy group), an aryloxy group (for example, a phenoxy group or a naphthyloxy group), a heterocycleoxy group, a silyloxy group, an acyloxy group (for example, an acetyloxy group, or a benzoyloxy group), a sulfonic acid group, a sulfonate group, an amino carbonyloxy group, an amino group (for example, an amino group, an ethyl amino group, a dimethyl amino group, a butyl amino group, a cyclopentyl amino group, a 2-ethylhexyl amino group, or a dodecyl amino group), an anilino group (for example, a phenyl amino group, a chlorophenyl amino group, a toluidino group, an anisidino group, a naphthyl amino group or a 2-pyridyl amino group), an imino group, a ureido group (for example, a methyl ureido group, an ethyl ureido group, a pentyl ureido group, a cyclohexyl ureido group, an octyl ureido group, a dodecyl ureido group, a phenyl ureido group, a naphthyl ureido group, or a 2-pyridyl amino ureido group), an alkoxy carbonyl amino group (for example, a methoxy carbonyl amino group or a phenoxy carbonyl amino group), an alkoxy carbonyl group (for example, a methoxy carbonyl group, an ethoxy carbonyl group, or phenoxy carbonyl), an aryloxy carbonyl group (for example, a phenoxy carbonyl group), a heterocyclicthio group, a thioureido group, a carboxyl group, a carboxylate group, a hydroxyl group, a mercapto group, and a nitro group. These substituents may be further substituted with the similar substituents.

In the above Formula (5), R₂₆ represents a hydrogen atom or a substituent, and the substituent represented by R₂₆ includes similar substituents to those represented by the above-described R₂₂ to R₂₅.

In the above Formula (5), n represents an integer of 1 or 2, and preferably 1.

In the above Formula (5), in the case where n is 1, R₂₁ represents a substituent, and in the case where n is 2, R₂₁ represents a bivalent linking group. In the case where R₂, represents a substituent, the substituent includes similar substituents to those represented by the above-described R₂₂ to R₂₅.

In the case where R₂₁ represent a linking group, examples of a bivalent linking group include an alkylene group which may have a substituent, an arylene group which may have a substituent, an oxygen atom, a nitrogen atom, a sulfur atom, or combinations of these linking groups.

A preferable lactone compound represented by the above Formula (5) includes compounds described in JP-A No. 7-233160, and JP-A No 7-247278.

Specific examples of a compound represented by the above Formula (5) are illustrated below, but the present invention is not limited by the examples below.

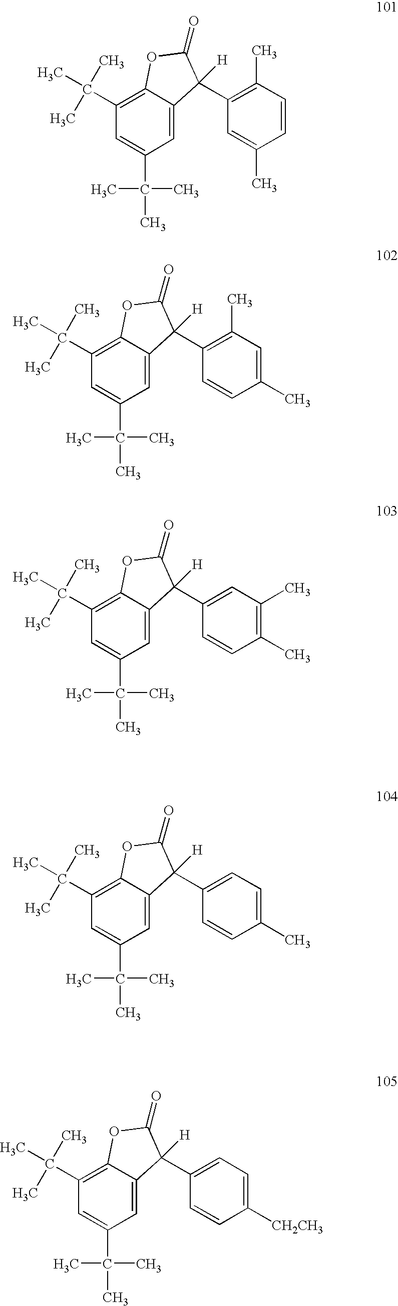

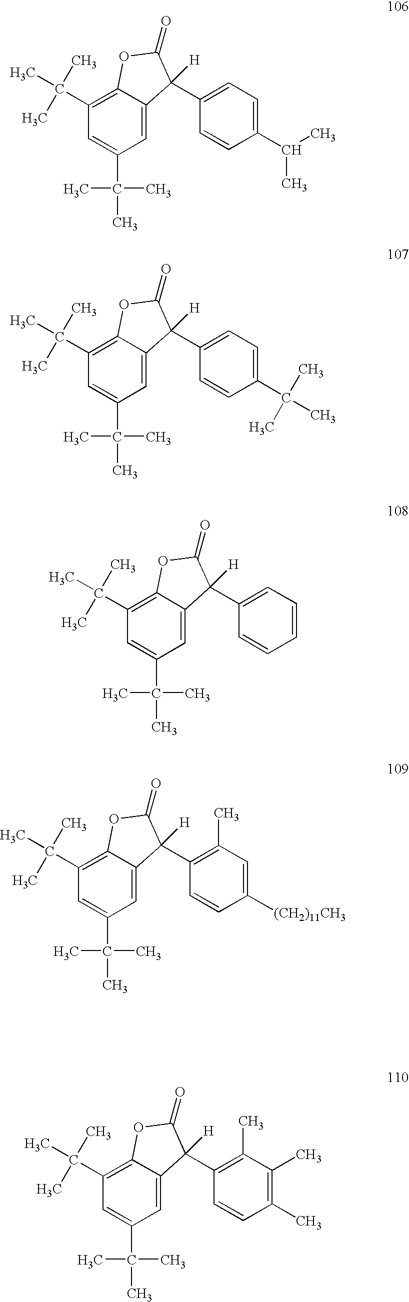

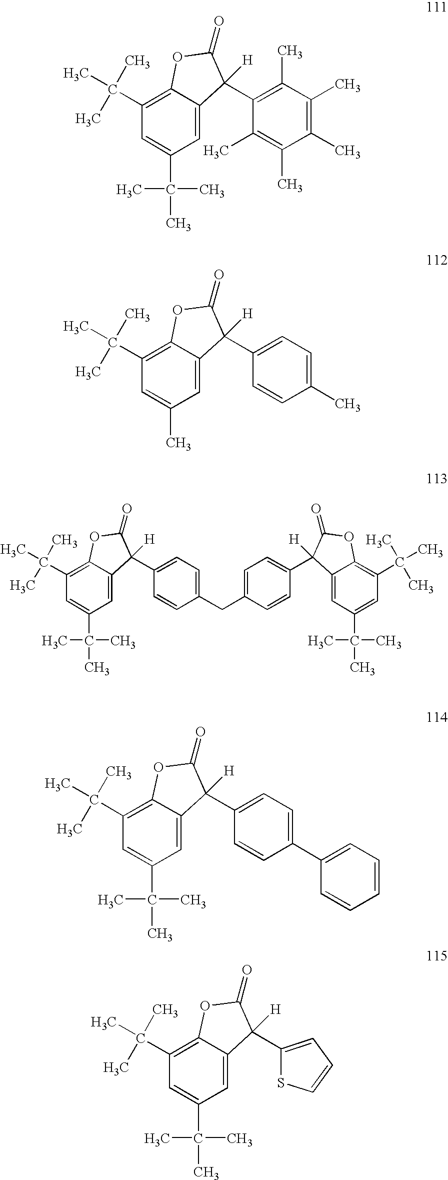

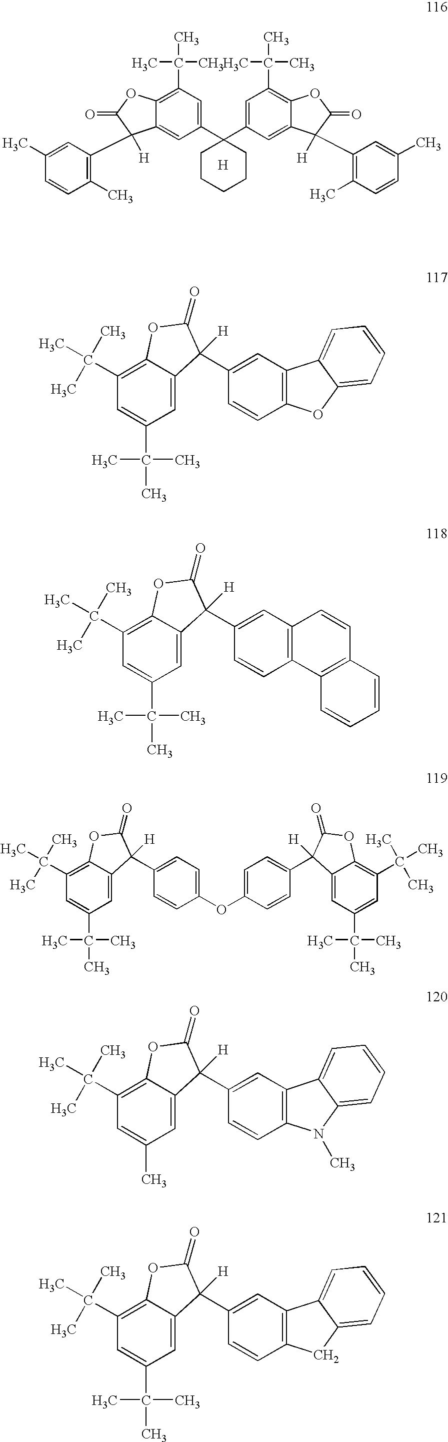

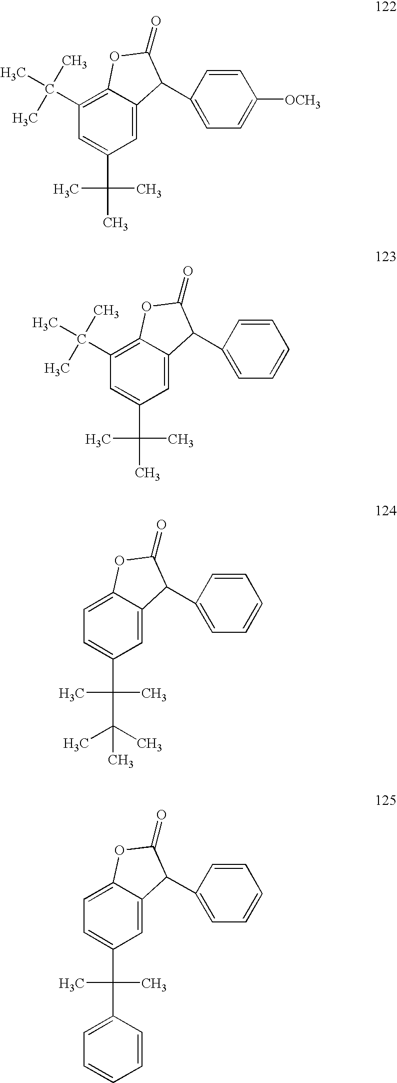

The above-described carbon radical scavengers can be used in combinations of each type thereof, or two or more of each type. A suitable blending quantity is suitably selected within a range of not detracting the purpose of the present invention, and usually 0.001 to 10.0 parts by mass, preferably 0.01 to 5.0 parts by mass, and more preferably 0.1 to 10 parts by mass with respect to 100 parts by mass of the cellulose ester.

### (UV Absorbers)

In view of minimizing degradation of polarizers and display units due to ultraviolet radiation, UV absorbers, which absorb ultraviolet radiation of a wavelength of at most 370 nm, are preferred, while in view of liquid crystal display properties, UV absorbers, which minimize absorption of visible light of a wavelength of at least 400 nm, are preferred. Examples of UV absorbers employed in the present invention include oxybenzophenone based compounds, benzotriazole based compounds, salicylic acid ester based compounds, benzophenone based compounds, cyanoacrylate based compounds, nickel complex based compounds, and triazine based compounds. Of these, preferred are benzophenone based compounds, as well as benzotriazole based compounds and triazine compounds which result in minimal coloration. Further, employed may be UV absorbers described in JP-A Nos. 10-182621 and 8-337574, as well as polymer UV absorbers described in JP-A Nos. 6-148430 and 2003-113317.

Specific examples of benzotriazole UV absorbers include, but are not limited to, 2-(2′-hydroxy-5′-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′, 5′-di-tert-butylphenyl)-5-chlorobenzotriazole, 2-(2′-hydroxy-3′-(3″,4″,5″, 6″-tetrahydrophthalimidomethyl)-5′-methylphenyl)benzotriazole, 2,2-methylenebis(4-(1,1,3,3-tetramethylbutyl)-6-(2H-benzotriazole-2-yl)phenol), 2-(2′-hydroxy-3′-tert-butyl-5′-methylphenyl)-5-chlorobenzotriazole, and 2-(2H-benzotriazole-2-yl)-6-(straight chain and branched chain dodecyl)-4-methylphenol, as well as a mixture of octyl-3-[3-tert-butyl-4-hydroxy-5-(chloro-2,4-benzotriazole-2-yl)phenyl]propionate and 2-ethylhexyl-3-[3-tert-butyl-4-hydroxy-5-(5-chloro-2H-benzotriazole-2-yl)phenyl]propionate.

Listed as such commercially available products are TINUVIN 171, TINUVIN 234, TINUVIN 360, all produced by Ciba Specialty Chemicals Co.) and LA 31 (produced by Asahidenka CO. Ltd.).

Specific examples of benzophenone compounds include, but are not limited to, 2,4-dihydroxybenzophenone, 2,2′-dihydroxy-4-methoxybenzopheneone, 2-hydroxy-4-methoxy-5-sulfobenzophenone, and bis(2-methoxy-4-hydroxy-5-benzoylphenylmethane).

In the present invention, the added amount of UV absorbers based on the weight of cellulose ester is preferably 0.1-5 percent by weight, is more preferably 0.2-3 percent by weight, but is still more preferably 0.5-2 percent by weight. These may be employed in combinations.

Further, these benzotriazole structure and benzophenone structure may be hung to a portion of polymers, or regularly to polymers and may further be incorporated into a part of the molecular structure of other additives such as plasticizers, antioxidants, or acid scavengers.

### (Hindered Amine Compounds)

other than above antioxidants, acid scavengers, and UV absorbers, listed as additives which enable retardation of decomposition of cellulose esters, via heat and light, are hindered amine compounds, which may be incorporated into the cellulose acylate film, if desired.

Hindered amine compounds (HALS) employed in the present invention include 2,2,6,6-tetraalkylpiperidine compounds, or acid addition salts thereof or metal complexes thereof, as described, for example, in columns 5-11 of U.S. Pat. No. 4,619,956 as well as columns 3-5 of U.S. Pat. No. 4,839,405. The above compounds are included in the compounds represented by Formula (6) below.

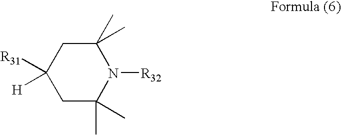

Wherein R₃₁ and R₃₂ each represent H or a substituent, Specific examples of hindered amine compounds include 4-hydroxy-2,2,6,6-tetramethylpiperidine, 1-allyl-4-hydroxy-2,2,6,6-tetramethylpiperidine, 1-benzyl-4-hydroxy-2,2,6,6-tetramethylpiperidine, 1-(4-t-butyl-2-butenyl)-4-hydroxy-2,2,6,6-tetramethylpiperidine, 4-stearoyloxy-2,2,6,6-tetramethylpiperidine, 1-ethyl-4-salycloyloxy-2,2,6,6-tetramethylpiperidine, 4-methacroyloxy-1,2,2,6,6-pentamethylpiperidine, 1,2,2,6,6-pentamethylpiperidine-4-yl-β(3,5-di-t-butyl-4-hydroxyphenyl)-propionate, 1-benzyl-2,2,6,6-tetramethyl-4-pyperidinyl maleinate₁ (di-2,2,6,6-tetramethylpiperidine-4-yl)-adipate, di-2,2,6,6-tetramethylpieridine-4-yl)-sebacate, (di-1,2,3,6-tetramethyl-2,6-diethyl-piperidine-4-yl) sebacate, (di-1-allyl-2,2,6,6-tetramethylpiperidine-4-yl)-phthalate, 1-acetyl-2,2,6,6-tetramethylpiperidine-4-yl-acetate, trimellitic acid-tri-(2,2,6,6-tetramethylpiperidine-4-yl) ester, 1-acryloyl-4-benzyloxy-2,2,6,6-tetramethylpiperidine, dibutyl-malonic acid-di-(1,2,2,6,6-pentamethyl-piperidine-4-yl)-ester, dibenzyl-malonic acid-di-(1,2,3,6-tetramethyl-2,6-dethyl-piperidine-4-yl)-ester, dimethyl-bis-(2,2,6,6-tetramethylpiperidine-4-oxy)-silane, tris-(1-propyl-2,2,6,6-tetramethylpiperidine-4-yl)-phosphite, tris-(1-propyl-2,2,6,6-tetramethylpiperidine-4-yl)-phosphate, N,N′-bis-(2,2,6,6-tetramethylpypeidine-4-yl)-hexamethylene-1,6-diamine, N,N′-bis-(2,2,6,6-tetramethylpiperidine-4-yl)-hexamethylene-1,6-diacetamide, 1-acetyl-4-(N-cyclohexylacetamido)-2,2,6,6-tetramethyl-piperidine, 4-benzylamino-2,2,6,6-tetramethylpiperidine, N,N′-bis-(2,2,6,6-tetramethylpiperidone-4-yl)-N,N′-dibutyl-adipamide, N,N′-bis (2,2,6,6-tetramethylpiperidine-4-yl)-N,N′dicyclohexyl-(2-hydroxyropylene), N,N′-bis-(2,2,6,6-tetramethylpiperidine-4-yl)-p-xylene-diamine, 4-(bis-2-hydroxyethyl)-amino-1,2,2,6,6-pentamethylpiperidine, 4-methacrylamido-1,2,2,6,6-pentaethylpiperidine, and α-cyano-β-methyl-β-[N-(2,2,6,6-tetramethylpiperidine-4-yl)]-amino-acrylate methyl ester, tetrakis(1,2,2,6,6-pentamethyl-6-pyperidyl)-1,2,3,4-butanetetracarboxylate. The examples of preferred hindered amine compounds include, but are not limited to, HALS-1 and HALS-2 below. A commercially available compound LA52 (Asahidenka Co. Ltd.) can be also cited.

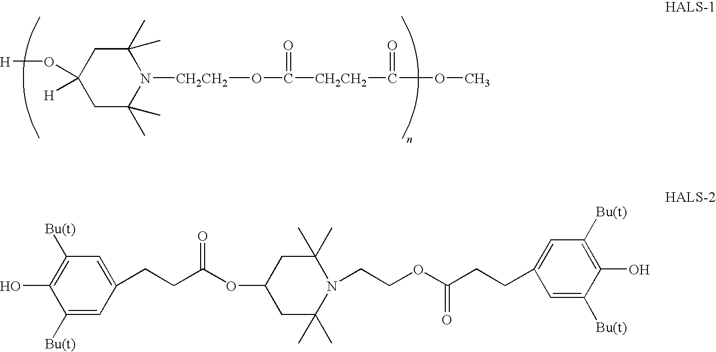

it is preferable that at least one of the above compounds is incorporated. The content is preferably 0.01-5 percent by weight with respect to the weight of the cellulose ester resins, is more preferably 0.1-3 percent by weight, but is still more preferably 0.2-2 percent by weight.

When the content of the above compounds is more than 0.01 weight %, thermal decomposition of cellulose ester resins tend to be prevented, and when it is less than 5 weight %, in view of compatibility to resins, sufficient transparency required for the polarizing plate protecting can be achieved and fragility of the film can be prevented. This range gives a preferable result.

### (Matting Agents)

In order to provide aimed slip properties, as well as to optical and mechanical functions, it is possible to incorporate matting agents into the cellulose acylate film of the present invention. Listed as such matting agents are minute particles of inorganic or organic compounds.

Preferably employed matting agents are spherical, rod-shaped, acicular, layered and tabular. Listed as matting agents are, for example, metal oxides such as silicon dioxide, titanium dioxide, aluminum oxide, zirconium oxide, calcium carbonate, kaolin, talc, calcined calcium silicate, hydrated calcium silicate, aluminum silicate, magnesium silicate, or calcium phosphate; minute inorganic particles composed of phosphoric acid salts, silicic acid salts, or carbonic acid salts; and minute crosslinking polymer particles. Of these, silicon dioxide is preferred due to a resulting decrease in film haze. It is preferable that these minute particles are subjected to a surface treatment, since it is possible to lower the film haze.

It is preferable to carry out the above surface treatment employing halosilanes, alkoxysilanes, silazane, or siloxane. As the average diameter of minute particles increases, slipping effects are enhanced. On the other hand, as it decreases, the resulting transparency increases. Further, the average diameter of the primary particles of the minute particles is customarily in the range of 0.01-1.0 μm, is preferably 5-50 nm, but is more preferably 7-14 nm. These minute particles are preferably employed to result in unevenness of 0.01-1.0 μm of the cellulose acylate film surface.

Listed as minute silicon dioxide particles are AEROSIL 200, 200V, 300, R972, R972V, R974, R202, R812, OX50, and TT600, all produced by Nihon Aerosil Corp. Of these, preferred are AEROSIL 200V, R972, R972V, R974, R202, and R812. Combination of two types of particles or more may be used.

When two types of the above are employed in combination, they may be mixed at an optional ratio and then employed. It is possible to use minute particles which differ in their average particle diameter and materials, such as ABROSIL 200V and R972V at a ratio of between 0.1:99.9 and 99-9:0.1 in terms of weight ratio.

These matting agents are added employing a method in which they are kneaded. Another method is that matting agents are previously dispersed and the resulting dispersion is blended with cellulose ester and/or plasticizers and/or UV absorbers. Thereafter, the resulting mixture is dispersed and subsequently solids are obtained by vaporizing the solvents or by performing precipitation. The resulting product is preferably employed in the production process of a cellulose ester melt since it is possible to uniformly disperse the matting agents into cellulose resins.

It is possible to incorporate the above matting agents to improve mechanical, electrical, and optical characteristics.

As the added amount of these minute particles increases, the slipping properties of the resultant cellulose acylate film are enhanced, while haze increases. The content is preferably 0.001-5 percent by weight, is more preferably 0.005-1 percent by weight, but is still more preferably 001-0.5 percent by weight.

The haze value of the cellulose acylate film of the present invention is preferably at most 1.0 percent, but is more preferably at most 0.5 percent, since optical materials at a haze value of at least 1.0 percent result in adverse effects. It is possible to determine the haze value based on JIS K 7136.

### (Melt Casting Method)

In the melting casting film making process, the film constituting material is required to produce only a small amount of volatile component or no volatile component at all. This is intended to reduce or avoid the possibility of foaming at the time of heating and melting, thereby causing a defect inside the film or deterioration in the flatness on the film surface.

When the film constituting material is melted, the percentage of the volatile component content is 1 percent by mass or less, preferably 0.5 percent by mass or less, more preferably 0.2 percent by mass or less, still more preferably 0.1 percent by mass or less. In the embodiment of the present invention, reduction in heating from 30° C. to 250° C. is measured and calculated using a differential thermogravimetric analyzer (TG/DTA200 by Seiko Electronic Industry Co., Ltd.). This amount is used to represent the amount of the volatile component contained.

Before film formation or at the time of heating, the aforementioned moisture and volatile component represented by the aforementioned solvent is preferably removed from the film constituting material to be used. It can be removed according to a known drying technique. Heating technique, reduced pressure technique or heating/pressure reduction technique can be utilized. The removing operation can be done in the air or under the atmosphere where nitrogen is used as an inert gas. When the aforementioned known drying technique is used, the temperature should be in such a range that the film constituting material is not decomposed. This is preferred to maintain satisfactory film quality.

Drying before formation of a film reduces the possibility of volatile components being generated. It is possible to dry the resin singly or to dry after separation into a mixture or compatible substance between the resin and at least one of the film constituting materials other than resin. The drying temperature is preferably 100° C. or more. If the material to be dried contains a substance having a glass transition temperature, the material may be welded and may become difficult to handle when heated to the drying temperature higher than the glass transition temperature thereof. Thus, the drying temperature is preferably below the glass transition temperature. If a plurality of substances have glass transition temperatures, the lower glass transition temperature is used as a standard. This temperature is preferably 100° C. or more without exceeding (glass transition temperature −5) ° C., more preferably 110° C. or more without exceeding (glass transition temperature −20) ° C. The drying time is preferably 0.5 through 24 hours, more preferably 1 through 18 hours, still more preferably 1.5 through 12 hours. If the drying temperature is too low, the volatile component removal rate will be reduced and the drying time will be prolonged. Further, the drying process can be divided into two steps. For example, the drying process may contain the steps; a preliminary drying step for material storage and an immediately preceding drying step to be implemented immediately before film formation through one week before film formation.

The melt-casting film forming method can be classified into molding methods for heating and melting. It is possible to use the melt extrusion molding method, press molding method, inflation method, injection molding methods blow molding method and orientation molding method. Of these, the melt extrusion method is preferred in order to ensure an cellulose acylate film characterized by excellent mechanical strength and surface accuracy. The following describes the film manufacturing method as an embodiment of the present invention with reference to the melt extrusion method.

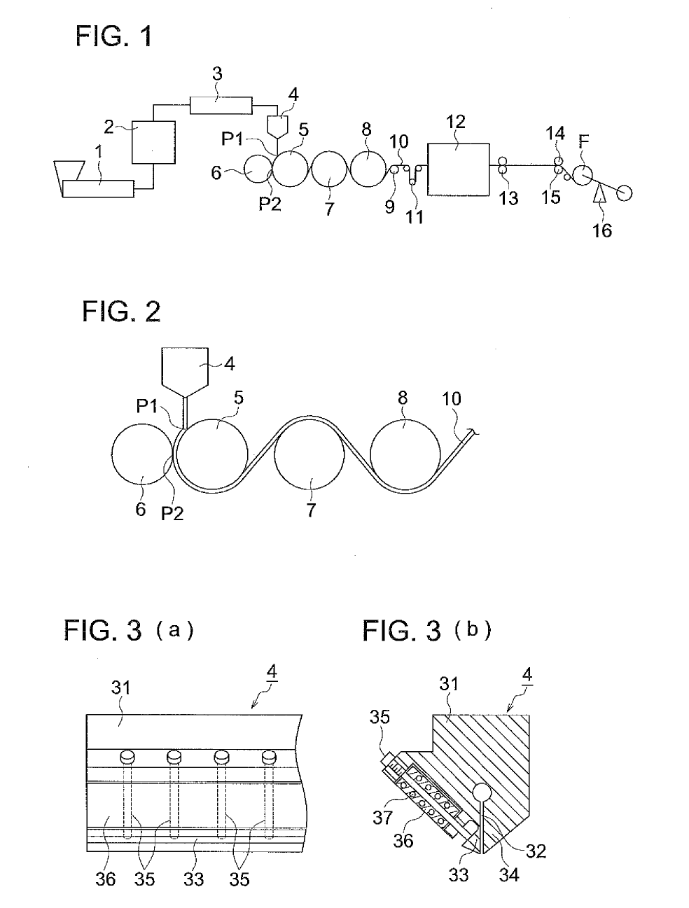

FIG. 1 is a schematic flow sheet representing one embodiment of an apparatus for embodying the manufacturing method of the cellulose acylate film as an embodiment of the present invention. FIG. 2 is an enlarged flow sheet representing the portion from flow casting die to the cooling roll.

In the film manufacturing method for a cellulose acylate film of the present invention shown in FIGS. 1 and 2, the film material such as a cellulose resin is mixed and then melt welding is performed by the extruder 1 from a flow casting die 4 to a first cooling roll 5 so as to circumscribe the material with the first cooling roll 5. Further, the material is cooled and solidified through sequential circumscription with a total of three cooling rolls including the second cooling roll 7, third cooling roll 8, whereby a film 10 is produced. Then both ends of the film 10 separated by the separation roll 9 are sandwiched by the orientation apparatus 12 and this film is oriented across the width. After that, the film is wound by a winding apparatus 16. Further, to improve the flatness, a touch roll 6 is provided to press (pinch) the melted film against a surface of a first cooling roll 5. The surface of this touch roll 6 is elastic and a nip is formed between this roll and the first cooling roll 5. The details of the touch roll 6 will be discussed later.

In the cellulose acylate film manufacturing method as an embodiment of the present invention, melt extrusion conditions can be the same as those used for the thermoplastic resin including other polyesters. In this case, the material is preferably dried in advance. A vacuum or pressure reduced dryer and a dehumidified hot air dryer is preferably used to dry so that the moisture will be 1000 ppm or less, more preferably 200 ppm or less.

For example, the cellulose ester based resin dried by hot air, under vacuum or under reduced pressure is extruded by an extruder 1, and is melted at an extrusion temperature of about 200 through 300° C., more preferably at about 230 through 260° C. This material is then filtered by a leaf disk type filter 2 or the like to remove foreign substances.

When the material is introduced from the supply hopper (not illustrated) to the extruder 1, it is preferred to create a vacuum, pressure reduced environment or inert gas atmosphere, thereby preventing decomposition by oxidation.

If such additive as a plasticizer is not mixed in advance, it can be added and kneaded during the extrusion process in the extruder. A mixing apparatus such as a static mixer 3 is preferably used to ensure uniform addition.

In the embodiment of the present invention, the cellulose resin and the additives such as a stabilizer to be added as required are mixed preferably before melting. The cellulose resin and stabilizer are more preferably mixed first. A mixer may be used for mixing. Alternatively, mixing may be done in the cellulose resin preparation process, as described above. When the mixer is used, it is possible to use a general mixer such as a V-type mixer, conical screw type mixer, horizontal cylindrical type mixer, Henschel mixer and ribbon mixer.

As described above, after the film constituting material has been mixed, the mixture can be directly melted by the extruder 1, thereby forming a film. It is also possible to make such arrangements that, after the film constituting material has been pelletized, the aforementioned pellets are melted by the extruder 1, thereby forming a film. Further, when the film constituting material contains a plurality of materials having different melting points, melting is performed at the temperature where only the material of lower melting point can be melted, thereby producing a patchy (spongy) half-melt. This half-melt is put into the extruder 1, whereby a film is formed. When the film constituting material contains the material that is easily subjected to thermal decomposition, it is preferred to use the method of creating a film directly without producing pellets for the purpose of reducing the number of melting, or the method of producing a patchy half-melt followed by the step of forming a film, as described above.

Various types of extruders sold on the market can be used as the extruder 1, and a melting and kneading extruder is preferably used. Either the single-screw extruder or twin screw extruder may be utilized. If a film is produced directly from the film constituting material without manufacturing the pellet, an adequate degree of kneading is required. Accordingly, use of the twin screw extruder is preferred. However, the single-screw extruder can be used when the form of the screw is modified into that of the kneading type screw such as a Maddox type, Unimelt type and Dulmage types because this modification provides adequate kneading. When the pellet and patchy half-melt is used as a film constituting material, either the single-screw extruder and twin screw extruder can be used.

In the process of cooling inside the extruder 1 or subsequent to extrusion, the density of oxygen is preferably reduced by replacement with such an inert gas as nitrogen gas or by pressure reduction.

The desirable conditions for the melting temperature of the film constituting material inside the extruder 1 differ depending on the viscosity of the film constituting material and the discharge rate or the thickness of the sheet to be produced. Generally, the melting temperature is Tg or more without exceeding Tg+100° C. with respect to the glass transition temperature Tg of the film, preferably Tg+10° C. or more without exceeding Tg+90° C. The melting viscosity at the time of extrusion is 10 through 100000 poises, preferably 100 through 10000 poises. Further, the film constituting material retention time in the extruder 1 is preferably shorter. This time is within 5 minutes, preferably within 3 minutes, more preferably within 2 minutes. The retention time depends on the type of the extruder 1 and conditions for extrusion, but can be reduced by adjusting the amount of the material supplied, and L/D, screw speed, and depth of the screw groove.

The shape and speed of the screw of the extruder 1 are adequately selected according to the viscosity of the film constituting material and discharge rate. In the embodiment of the present invention, the shear rate of the extruder 1 is 1/sec through 10000/sec, preferably 5/sec through 1000/sec, more preferably 10/sec through 100/sec.

The extruder 1 in the embodiment of the present invention can generally be obtained as a plastic molding machine.

The film constituting material extruded from the extruder 1 is sent to the flow casting die 4 and is extruded from the slit of the flow casting die 4 in the form of a film. There is no restriction to the flow casting die 4 if it can be used to manufacture a sheet and film. The material of the flow casting die 4 is exemplified by hard chromium, chromium carbide, chromium nitride, titanium carbide, titanium carbonitride, titanium nitride, cemented carbide and ceramics (e.g., tungsten carbide, aluminum oxide, chromium oxide), which are sprayed or plated, and are subjected to surface treatment by buffing, lapping with a grinding wheel having a count 1000 and after, plane cutting with a diamond wheel having a count 1000 (cutting in the direction perpendicular to the resin flow), electrolytic polishing, and composite electrolytic polishing. The preferred material of the lip of the flow casting die 4 is the same as that of the flow casting die 4. The surface accuracy of the lip is preferably 0.5S or less, more preferably 0.2S or less.

The slit of this flow casting die 4 is constructed so that the gap can be adjusted. This is illustrated in FIG. 3. One of a pair of lips constituting the slit 32 of the flow casting die 4 is a flexible lip 33 which is less rigid and more likely to deform. The other is a stationary lip 34. A great many heat bolts 35 are arranged at a predetermined pitch across the width of the flow casting die 4, namely, along the length of the slit 32. Each of the heat bolts 35 is provided with a block 36, which is equipped with an embedded electric heater 37 and coolant passage. Each of the heat bolts 35 is led through each of the blocks 36 in the longitudinal direction. The base of the heat bolt 35 is secured to the die body 31, and the tip end is engaged with the external surface of the flexible lip 33. While the block 36 is air-cooled at all times, the input of the embedded electric heater 37 is adjusted, and the temperature of the block 36 is also adjusted. This procedure provides thermal extension and contraction of the heat bolt 35, and displaces the flexible lip 33, whereby the thickness of the film is adjusted. A thickness gauge is arranged at required positions in the wake of the die. The information on web thickness having been detected by this gauge is fed back to the control apparatus. The information on the thickness is compared with the preset thickness information by a control apparatus, and the power or on-rate of the heat generating member of the heat bolt can be controlled in response to the signal of correction control amount coming from this apparatus. The heat bolt preferably has a length of 20 through 40 cm and a diameter of 7 through 14 mm. A plurality of heat bolts (e.g., scores of heat bolts) are arranged preferably at a pitch of 20 through 40 mm. Instead of the heat bolt, it is possible to provide a gap adjusting member mainly made up of a bolt that adjusts the slip gap by manual movement in the longitudinal direction along the axis. The slit gap adjusted by the gap adjusting member is normally 200 through 1000 μm, preferably 300 through 800 μm, more preferably 400 through 600 μm.

The first through third cooling rolls are seamless steel tubes having a wall thickness of about 20 through 30 mm, and the surfaces thereof are mirror-finished. A tube is provided inside to allow coolant to flow, and the heat from the film on the roll is absorbed by the coolant flowing through the tube. Of these first through third cooling rolls, the first cooling roll 5 corresponds to the rotary support member of the present invention.

In the meantime, the surface of the touch roll 6 engaged with the first cooling roll 5 is elastic and is deformed along the surface of the first cooling roll 5 by the pressure applied to the first cooling roll 5, whereby a nip is formed between the touch roll 6 and the first roll 5. To be more specific, the touch roll 6 corresponds to the rotary pinch member of the present invention.

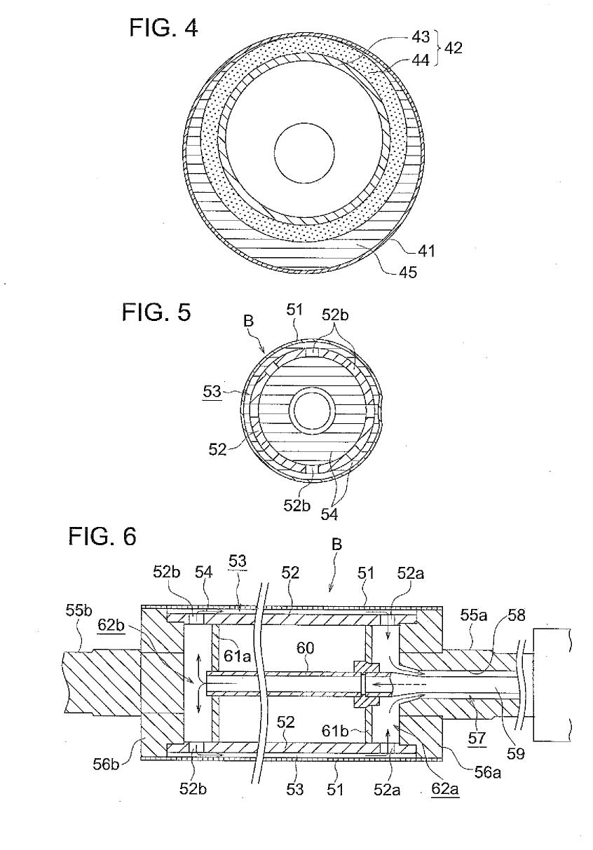

FIG. 4 is a schematic cross sectional view of an equipment (hereinafter referred to as “touch roll A”) of the touch roll 6. As illustrated, the touch roll A is made up of an elastic roller 42 arranged inside the flexible metallic sleeve 41.

The metallic sleeve 41 is made of stainless steel having a thickness of 0.3 mm, and is flexible. If the metallic sleeve 41 is too thin, the strength will be insufficient. If the thickness is excessive, elasticity will be insufficient. This signifies that the thickness of the metallic sleeve 41 is preferably 0.1 mm or more without exceeding 1.5 mm. To be more specific, if the thickness of the metallic sleeve 41 is below 0.1 mm, the strength becomes insufficient, and the sleeve breaks after a short-term use. In the meantime, if the thickness of the metallic sleeve 41 is above 1.5 mm, elasticity is insufficient, and this prevents deformation from occurring along the surface of the first cooling roll 5. The elastic roller 42 is structured in such a way that a rubber 44 is arranged on the surface of the metallic inner cylinder 43 which is freely rotated through the bearing, and is shaped into a roll. When the touch roll A is pressed against the first cooling roll 5, the elastic roller 42 causes the metallic sleeve 41 to be pressed against the first cooling roll 5. The metallic sleeve 41 and elastic rollers 42 are deformed in conformity to the shape of the first cooling roll 5, whereby a nip is formed between this roll and the first cooling roll. Coolant 45 flows through the space formed between the metallic sleeve 41 and the elastic roller 42.

FIGS. 5 and 6 show a touch roll B as another embodiment of the rotary pinch member. The touch roll B approximately includes an outer cylinder 51 made of a flexible and seamless stainless steel tube (thickness; 4 mm), and a highly rigid metallic inner cylinder 52 arranged on the same axial form inside this outer cylinder 51. Coolant 54 flows through the space 53 between the outer cylinder 51 and the inner cylinder 52. To put it in greater details, the touch roll B is constructed in such way that the rotary shafts 55a and 55b on both ends are provided with outer cylinder support flanges 56a and 56b, and a thin metallic outer cylinder 51 is mounted between the outer peripheral portions on both of these outer cylinder support flanges 56a and 56b A fluid supply tube 59 is arranged in the same axial form in the fluid outlet 58 which is formed on the axial portion of the rotary shaft 55a to form a fluid return passage 57. This fluid supply tube 59 is fixed by connection with the fluid bush 60 arranged on the axial portion inside the thin metallic outer cylinder 51. Both ends of this fluid bush 60 are provided, respectively with the inner cylinder support flanges 61a and 61b. A metallic inner cylinder 52 having a thickness of about 15 through 20 mm is mounted over the distance from between the outer peripheral portions of these inner cylinder support flanges 61a and 61b to the outer cylinder support flange 56b on the other end. A coolant flow space 53 of about 10 mm is formed between this metallic inner cylinder 52 and thin metallic outer cylinder 51. An outlet 52a and inlet 52b for communicating with the flow space 53 and intermediate passages 62a and 62b outside the inner cylinder support flanges 61a and 61b are formed in the vicinity of both ends of the metallic inner cylinder 52, respectively.

To provide softness, flexibility and stability comparable to that of rubber elasticity, the outer cylinder 51 is made as thin as possible to the extent to which the thin cylinder theory of elastodynamics is applicable. The flexibility evaluated according to the thin cylinder theory is expressed in terms of wall thickness t/roll radius r. The smaller the t/r, the higher the flexibility. The optimum flexibility of the touch roll B is achieved when t/r≦0.03. Normally, a commonly used touch roll is long from side to side, with a roll diameter R of 200 through 500 mm (roll radius r=R/2), a roll effective width L of 500 through 1600 mm, wherein r/L<1. As shown in FIG. 6, when the roll diameter R is 300 mm and the roll effective width L is 1200 mm, the wall thickness t is applicable to 150×0.03=4.5 mm or less. When pressure is applied to the melted sheet width of 1300 mm at the average linear pressure of 10 kN/m, the wall thickness of the outer cylinder 51 is 3 mm as compared with the rubber roll of the same profile. Thus, approximately the same value as the nip width of 12 mm of this rubber roll is recorded when the equivalent spring constant is the same and the nip width k of the roll d having a nip between the outer cylinder 51 and cooling roll is also about 9 mm. Thus, it is apparent that pressure can be applied under the same conditions. It should be noted that deflection is about 0.05 through 0.1 mm at the aforementioned nip width k.

In the above description, t/r≦0.03 is assumed as constituting the optimum condition. If the t/r≦0.05 is used, sufficient flexibility can be obtained. If t/r is above 0.05, flexibility will be insufficient and this disables deformation along the surface of the first cooling roll 5. In the case of a general roll diameter R of 200 through 500 mm, especially in the range of 2 mm≦t≦5 mm, sufficient flexibility is ensured, and the thickness can be easily reduced by machining. This provides a very practical range. If the wall thickness is 2 mm or less, high-precision machining will be disabled by elastic deformation at the time of machining, and manufacturing will be difficult.

The equivalent of the aforementioned 2 mm≦t≦5 mm is 0.008≦t/r≦0.05 for a common roll diameter. To be more specific, if the t/r is below 0.008, manufacturing will be difficult. For practical purposes, the wall thickness should be increased in proportion to the roll diameter when the t/r≈is 0.03. For example, the range is t=2 through 3 mm when the roll diameter R is 200, and t=4 through 5 mm when roll diameter R is 500.

The aforementioned touch rolls A and B are energized in the direction of the first cooling roll by the energizing device (not illustrated). The value F/W (linear pressure) obtained by dividing the energizing force F of the energizing device by width W of the film in the nip along the rotary shaft of the first cooling roll 5 is set at 1 kN/m or more without exceeding 15 kN/m. According to the present embodiment, a nip is formed between the touch rolls A and B, and the first cooling roll 5. Flatness can be corrected while the nip passes through the aforementioned nip. Accordingly, as compared to the case where the touch roll is made up of a rigid body without a nip being formed between this roll and the first cooling roll, the film is pressed at a smaller linear pressure for a longer time. This arrangement ensures more reliable correction of the flatness. To be more specific, if the linear pressure is smaller than 1 kN/m, the die line cannot sufficiently be removed. Conversely, of the linear pressure is greater than 15 kN/m, the film cannot pass through the nip, with the result that irregularity will be produced. If the linear pressure is set at 5 kN/m or more without exceeding 10 kN/m, the die line can be removed very effectively, and the irregularity in film thickness can be minimized.

Further, because the surfaces of the touch rolls A and B are made of metal, they can be made smoother than when the surfaces of the touch rolls are made of rubber, so that a very smooth film can be produced. Ethylene propylene rubber, neoprene rubber and silicon rubber can be used to manufacture the elastic body 44 of the elastic roller 42.

To ensure effective removal of the die line by the touch roll 6, it is important that the viscosity of the film sandwiched and pressed by the touch roll 6 should be within a pertinent range. Further, the cellulose resin is known to be subjected to a greater change in the viscosity by temperature. Thus, in order to ensure that the viscosity of the cellulose film sandwiched and pressed by the touch roll 6 is set in a pertinent range, the temperature of the cellulose film sandwiched and pressed by the touch roll 6 should be set in a pertinent range. The present inventors have found out that, when the glass transition temperature of the optical film is assumed as Tg, the film temperature T immediately before the film is sandwiched and pressed by the touch roll 6 should be set so as to meet Tg<T<Tg+110° C. If the film temperature T is lower than Tg, film viscosity will be too high to correct the die line. Conversely, if the film temperature T is higher than Tg+110° C., uniform adhesion between the film surface and roll cannot be achieved, with the result that the die line cannot be corrected. This temperature is preferably Tg+10° C.<T<Tg+90° C., more preferably Tg+20° C.<T<Tg+70° C. The temperature of the cellulose film sandwiched and pressed by the touch roll 6 can be set to a pertinent range by adjusting the length L from the nip between the first cooling roll 5 and touch roll 6, along the rotational direction of the first cooling roll 5, to the position P1 wherein the melt extruded from the flow casting die 4 is brought in contact with the first cooling roll 5.

In the embodiment of the present invention, carbon steel, stainless steel and resin are preferably used as a material of the first roll 5 and the second roll 6. Further, the surface accuracy is preferably improved. The surface roughness is preferably 0.3S or less, more preferably 0.01S or less.

In the embodiment of the present invention, it has been found out that, if the pressure is reduced to 70 kPa or less in the portion from the opening (lip) of the flow casting die 4 to the first roll 5, the aforementioned die line can be effectively corrected. In this case, this pressure is preferably reduced to 50 kPa or more without exceeding 70 kPa. There is no restriction to the method for ensuring that the pressure in the portion from the opening (lip) of the flow casting die 4 to the first roll 5 is kept at 70 kPa or less. For example, it is possible to reduce the pressure if the portion around the roll from the flow casting die 4 is covered with a pressure resistant member. In this case, a suction apparatus is preferably heated by a heater so that a sublimate is not deposited on the apparatus per se. In the embodiment of the present invention, if the suction pressure is too small, a sublime cannot be effectively sucked. This requires an appropriate suction pressure to be selected.

In the embodiment of the present invention, while the melted film-like cellulose ester-based resin coming from the flow casting die 4 is conveyed by sequential contact with the first roll (the first cooling roll) 5, second cooling roll 7 and third cooling roll 8, the resin is cooled and solidified, whereby an unoriented cellulose ester based resin film 10 is obtained.

In the embodiment of the present invention shown in FIG. 1, the film 10 which is separated from the third cooling roll 8 by the separation roll 9 and is cooled, solidified and unoriented is led to the drawing machine 12 through the dancer roll (film tension adjusting roll) 11. The film 10 is drawn in the lateral direction (across the width) by this drawing machine. This process of drawing causes the molecules to be oriented in the film.

A known tenter can be preferably used to draw the film across the width. Particularly, drawing the film across the width allows the lamination with the polarizing film to be implemented in the form of a roll. Drawing across the width ensures that the slow axis of the optical film made up of the cellulose ester based resin film is oriented across the width.

The transmission axis of the polarizing film is usually oriented across the width too. The polarizing plate, which is laminated in such a way that the transmission axis of the polarizing film and the slow axis of the optical film is parallel to each other, is incorporated into the liquid crystal display, this arrangement improves the display contrast of the liquid crystal display, and provides an excellent viewing angle.

The glass transition temperature Tg of the film constituting material can be controlled when the types of the materials constituting the film and the proportion of the constituting materials are made different. When the retardation film is manufactured as an optical film, it is preferable that Tg is 120° C. or more, preferably 135° C. or more. In the liquid crystal display, the film temperature environment is changed in the image display mode by the temperature rise of the apparatus per se, for example, by the temperature rise caused by a light source. In this case, if the Tg of the film is lower than the film working environment temperature, a big change will occur to the retardation value and film geometry resulting from the orientation status of the molecules fixed inside the film by drawing. If the Tg of the film is too high, temperature is raised when the film constituting material is formed into a film. This will increase the amount of energy consumed for heating. Further, the material may be decomposed at the time of forming a film, and this may cause coloring. Thus, Tg is preferably kept at 250° C. or less.

The process of cooling and relaxation under known thermal setting conditions can be applied in the drawing process. Appropriate adjustment should be made to obtain the characteristics required of the intended optical film.

The aforementioned drawing process and thermal setting process are applied as appropriate to provide the phase film function for the purpose of improving the physical properties of the phase film and to increase the viewing angle in the liquid crystal display. When such a drawing process and thermal setting process are included, the heating and pressing process in the embodiment of the present invention should be performed prior to the drawing process and thermal setting process.

When a retardation film is produced as an optical film, and the functions of the polarizing plate protective film are combined, control of the refractive index is essential. The refractive index control can be provided by the process of drawing. The process of drawing is preferred. The following describes the method for drawing.

In the retardation film drawing process, required retardations Ro and Rth can be controlled by a drawing magnification of 1.0 through 2.0 in one direction of the cellulose resin, and a drawing magnification of 1.01 through 2.5 times in the direction perpendicular to the inner surface of the film. Here Ro denotes an in-plane retardation. It represents the thickness multiplied by the difference between the refractive index in the longitudinal direction MD in the same plane and that across the width TD. Rth denotes the retardation along the thickness, and represents the thickness multiplied by the difference between the refractive index (an average of the values in the longitudinal direction MD and across the width TD) in the same plane and that along the thickness.

Drawing can be performed sequentially or simultaneously, for example, in the longitudinal direction of the film and in the direction perpendicular in the same plane of the film, namely, across the width. In this case, if the drawing magnification at least in one direction is insufficient, sufficient phase difference cannot be obtained. If it is excessive, drawing difficulties may occur and the film may break.

Drawing in the biaxial directions perpendicular to each other is an effectively way for keeping the film refractive indexes nx, ny and nz within a predetermined range. Here nx denotes a refractive index in the longitudinal direction MD, ny indicates that across the width TD, and nz represents that along the thickness.

When the material is drawn in the melt-casting direction, the nz value will be excessive if there is excessive shrinkage across the width. This can be improved by controlling the shrinkage of the film across the width or by drawing across the width. In the case of drawing across the width, distribution may occur to the refractive index across the width. This distribution may appear when a tenter method is utilized. Drawing of the film across the width causes shrinkage force to appear at the center of the film because the ends are fixed in position. This is considered to be what is called “bowing”. In this case, bowing can be controlled by drawing in the casting direction, and the distribution of the phase difference across the width can be reduced.

Drawing in the biaxial directions perpendicular to each other reduces the fluctuation in the thickness of the obtained film. Excessive fluctuation in the thickness of the retardation film will cause irregularity in phase difference. When used for liquid crystal display, irregularity in coloring or the like will occur.

The fluctuation in the thickness of the cellulose resin film is preferably kept within the range of ±3%, further down to ±1%. To achieve the aforementioned object, it is effective to use the method of drawing in the biaxial directions perpendicular to each other. In the final phase, the magnification rate of drawing in the biaxial directions perpendicular to each other is preferably 1.0 through 2.0 in the casting direction, and 1.01 through 2.5 across the width. Drawing in the range of 1.01 through 1.5 in the casting direction and in the range of 1.05 through 2.0 across the width will be more preferred to get a retardation value.

When the absorption axis of the polarizer is present in the longitudinal direction, matching of the transmission axis of the polarizer is found across the width. To get a longer polarizing plate, the retardation film is preferably drawn so as to get a slow axis across the width.

When using the cellulose resin to get positive double refraction with respect to stress, drawing across the width will provide the slow axis of the retardation film across the width because of the aforementioned arrangement. In this case, to improve display quality, the slow axis of the retardation film is preferably located across the width. To get the target retardation value, it is necessary to meet the following relationship:

(Drawing magnification across the width)>(drawing

magnification in casting direction)

After drawing, the end of the film is trimmed off by a slitter 13 to a width predetermined for the product. Then both ends of the film are knurled (embossed) by a knurling apparatus made up of an emboss ring 14 and back roll 15, and the film is wound by a winder 16. This arrangement prevents sticking in the optical film F (master winding) or scratch. Knurling can be provided by heating and pressing a metallic ring having a pattern of projections and depressions on the lateral surface. The gripping portions of the clips on both ends of the film are normally deformed and cannot be used as a film product. They are therefore cut out and are recycled as a material.

When the retardation film is used as a protective film of the polarizing plate, the thickness of the aforementioned protective film is preferably 10 through 500 μm. Particularly, the lower limit is 20 μm or more, preferably 35 μm or more. The upper limit is 150 μm or less, preferably 120 μm or less. A particularly preferred range is 25 through 90 μm. If the retardation film is too thick, the polarizing plate subsequent to machining will be too thick. This fails to meet low-profile light weight requirements when employed in the liquid crystal display for a notebook PC or mobile type electronic equipment. Conversely, if the retardation film is too thin, retardation as a retardation film cannot occur easily. Further, the film moisture permeability will be increased, with the result that the polarizer cannot be effectively protected from moisture. This must be avoided.

The slow axis or fast axis of the retardation film is present in the same plane of the film. Assume that the angle with respect to the direction of film formation is θ1. Then the θ1 should be −1 degrees or more without exceeding +1 degrees, preferably −0.5 degrees or more without exceeding +0.5 degrees.

This θ1 can be defined as an orientation angle. It can be measured by an automatic double refractometer KOBRA −21ADH (made by Oji Scientific Instruments).

If θ1 meets the aforementioned relationship, a high degree of brightness is ensured in the display image and a leakage of light is reduced or prevented, with the result that faithful color representation is provided in the color liquid crystal display.

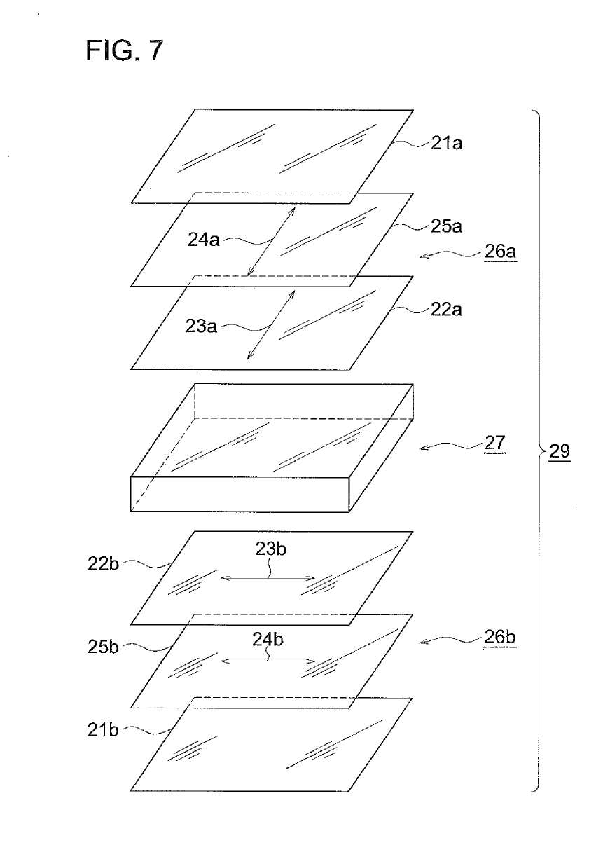

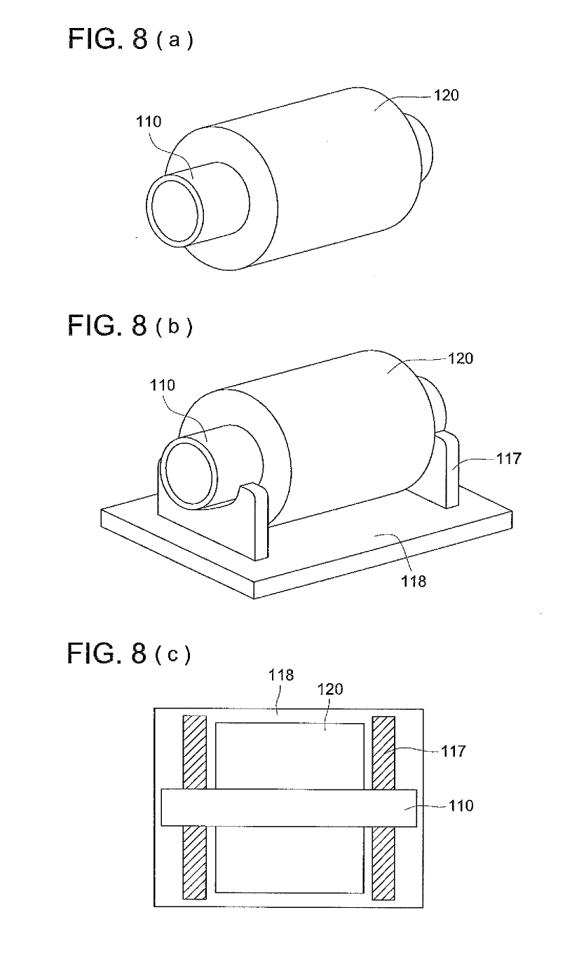

When the retardation film as an embodiment of the present invention is used in the multiple-domain VA mode, the arrangement of the retardation film improves the display quality of the image if the fast axis of the retardation film is θ1, and the film is arranged in the aforementioned area. When the polarizing plate and liquid crystal display device are set to MVA mode, a structure shown in FIG. 7 can be used, for example.

In FIG. 7, the reference numerals 21a and 21b indicate protective films, 22a and 22b represent retardation films, 25a and 25b show polarizers, 23a and 23b indicate the slow axis directions of the film, 24a and 24b show the directions of the polarizer transmission axis, 26a and 26b denote polarizing plates, 27 shows a liquid crystal cell, and 29 denotes a liquid crystal display.

The distribution of the retardation Ro in the in-plane direction of the optical film is adjusted to preferably 5% or less, more preferably 2% or less, still more preferably 1.5% or less. Further, the distribution of retardation Rt along the thickness of the film is adjusted to preferably 10% or less, more preferably 2% or less, still more preferably 1.5% or less.

In the retardation film, the fluctuation in the distribution of the retardation value is preferred to be as small as possible. When a polarizing plate containing the retardation film is used in the liquid crystal display device, a smaller fluctuation in the distribution of the aforementioned retardation is preferred for the purpose of preventing color irregularity.

In order to adjust the retardation film so as to provide the retardation value suited for improvement of the display quality of the liquid crystal cell in the VA mode or TN mode and to divide the aforementioned multi-domain especially in the VA mode for preferable use in the MVA mode, adjustment must be made to ensure that the in-plane retardation Ro is greater than 30 nm without exceeding 95 nm, and retardation Rt along the thickness is greater than 70 nm without exceeding 400 nm.

In the configuration shown in FIG. 7 wherein two polarizing plates are arranged in a crossed-Nicols configuration and a liquid crystal cell is arranged between the polarizing plates, assuming a crossed-Nicols configuration with respect to the standard wherein observation is made from the direction normal to the display surface. When viewed from the direction away from the line normal to the display surface, a deviation occurs from the crossed-Nicols arrangement of the polarizing plate, and causes the leakage of light. This leakage is mainly compensated for by the aforementioned in-plane retardation Ro. In the aforementioned TN mode and VA mode, particularly in the MVA mode, when the liquid crystal cell is set to the black-and-white display mode, the retardation along the thickness mainly compensates for the double refraction of the liquid crystal cell recognized when viewed in a slanting direction in the same manner.

As shown in FIG. 7, when two polarizing plates are arranged on the upper and lower portions of the liquid crystal cell in the liquid crystal display, the reference numerals 22a and 22b in FIG. 7 are capable of selecting the distribution of retardation Rt along the thickness. It is preferred to ensure that the requirements of the aforementioned range are met, and the total of both of the retardations Rt along the thickness is greater than 140 nm without exceeding 500 nm. In this case, both the in-plane retardation Ro of the 22a and 22b and retardation Rt along the thickness retardation Rt are the same for improving the productivity of industrial polarizing plates. It is particularly preferred that the in-plane retardation Ro is greater than 35 nm without exceeding 65 nm, the retardation Rt along the thickness retardation Rt is greater than 90 nm without exceeding 180 nm, and the structure shown in FIG. 7 is applied to the liquid crystal cell in the MVA mode.

In the liquid crystal display device, assuming that the TAC film having an in-plane retardation Ro of 0 through 4 nm, a retardation Rt along the thickness of 20 through 50 nm and a thickness of 35 through 85 μm is used at the position 22b in FIG. 7 as one of the polarizing plates, for example, as a commercially available polarizing plate protective film, the polarizing film arranged on the other polarizing plate, for example, the polarizing film arranged in 22a of FIG. 7 is preferred to have an in-plane retardation Ro of greater than 30 nm without exceeding 95 nm, and the retardation Rt along the thickness of greater than 140 nm without exceeding 400 nm. This arrangement improves the display quality and film productivity

### <Liquid Crystal Display Devices>

The polarizing plate including the cellulose acylate film (called as a retardation film) in the embodiment of the present invention provides higher display quality than the normal polarizing plate. This is particularly suited for use in a multi-domain type liquid crystal display, more preferably to the multi-domain type liquid crystal display in the double refraction mode.

The polarizing plate of the present invention as an embodiment of the present invention can be used in the MVA (Multi-domain Vertical Alignment) mode, PVA (Patterned vertical Alignment) mode, CPA (Continuous Pinwheel Alignment) mode and OCB (Optical Compensated Bend) mode, without being restricted to a specific liquid crystal mode or polarizing plate arrangement.

The liquid crystal display is coming into practical use as a colored and animation display. The display quality is improved by the embodiment of the present invention. The improved contrast and enhanced polarizing plate durability ensure faithful animation image display without easy fatigue In the liquid crystal display containing at least the polarizing plate incorporating a retardation film in the embodiment of the present invention, one polarizing plate containing the retardation film in the embodiment of the present invention is arranged on the liquid crystal cell, or two polarizing plates are arranged on both sides of the liquid crystal cell. In these cases, the display quality is improved when means are provided to ensure that the side of the retardation film in the embodiment of the present invention contained in the polarizing plate faces the liquid crystal cell of the liquid crystal display. Then the films 22a and 22b of FIG. 7 face the liquid crystal cell of the liquid crystal display.

In the aforementioned structure, the retardation film in the embodiment of the present invention provides optical compensation of the liquid crystal cell. When the polarizing plate in the embodiment of the present invention is used in the liquid crystal display, at least one of the polarizing plates of the liquid crystal display should be used as a polarizing plate in the embodiment of the present invention. Use of the polarizing plate in the embodiment of the present invention improves the display quality and provides a liquid crystal display having excellent viewing angle.

In the polarizing plate of the embodiment of the present invention, a polarizing plate protective film of cellulose derivative is used on the surface opposite the retardation film as viewed from the polarizer. A general-purpose TAC film or the like can be employed as the protective film. The polarizing plate protective film which is located far from the liquid crystal cell, can be provided with another functional layer for the purpose of improving the quality of the display apparatus.

For example, in order to avoid reflection, glare, scratch and dust, and to improve brightness, it is possible to bond the aforementioned functional layer onto the film containing a known functional layer for a display or polarizing plate surface in the embodiment of the present invention, without being restricted thereto.

Generally, to ensure stable optical characteristics, the aforementioned retardation value Ro or Rth are required to be small for the retardation film. Especially, these fluctuations may cause irregularities of an image in the liquid crystal display in the double refraction mode.

In the embodiment of the present invention, a longer retardation film produced by the melt-casting film forming method is mainly made of a cellulose resin. This arrangement makes it possible to use the process of alkaline treatment based on the saponification inherent to the cellulose resin. Similarly to the case of the conventional polarizing plate protective film, this can be bonded with the retardation film in the embodiment of the present invention using an aqueous solution containing a completely saponified polyvinyl alcohol, when the resin constituting the polarizer is polyvinyl alcohol. Thus, the embodiment of the present invention is superior in that the method for manufacturing the conventional polarizing plate can be applied. It is especially advantageous in that a longer roll polarizing plate can be obtained.

The advantage in production of the embodiment of the present invention is more remarkable especially in the production of a longer product in excess of 100 meters. Greater advantages are observed in the production of a polarizing plate when it is longer, for example, in the order of 1500 m, 2500 m and 5000 m.

For example, in the production of a retardation film, roll length is 10 m or more without exceeding 5000 m, preferably 50 m or more without exceeding 4500 m when the productivity and transportability are taken into account. The width of a polarizer can be selected being suitable for the width of the polarizer and the production line in this case. A film having a width of 0.5 m or more without exceeding 4.0 m, preferably 0.6 m or more without exceeding 3.0 m can be produced, wound in a form of a roll, and used to process a polarizing plate. A film having a width twice or more as great as the intended width also can be produced, wound in a form of a roll, and cut to get the roll of an intended width, and used to process the polarizing plate.

When manufacturing the cellulose acylate film as the embodiment of the present invention, a functional layer such as antistatic layer, hard coated layer, glide promoting layer, adhesive layer, antiglare layer and barrier layer can be coated before and/or after drawing. In this case, various forms of surface treatment such as corona discharging, plasma processing, chemical solution treatment can be provided as appropriate.

In the film making process, the gripping portions of the clips on both ends of the film having been cut can be recycled as the material of the same type or different type of films, after having been pulverized, or after having been pelletized as required.

An optical film of lamination structure can be produced by co-extrusion of the compositions containing cellulose resins having different concentrations of additives such as the aforementioned plasticizer, ultraviolet absorber and matting agent. For example, an optical film made up of a skin layer, core layer and skin layer can be produced. For example, a large quantity of matting agent can be put into the skin layer or the matting agent can be put only into the skin layer. Larger amounts of plasticizer and ultraviolet absorber can be put into the core layer than the skin layer. They can be put only in the core layer. Further, the types of the plasticizer and ultraviolet absorber can be changed in the core layer and skin layer. For example, it is also possible to make such arrangements that the skin layer contains a plasticizer and/or ultraviolet absorber of lower volatility, and that the core layer contains a plasticizer of excellent plasticity or an ultraviolet absorber of excellent ultraviolet absorbing performance. The glass transition temperatures between the skin layer and core layer can be different from each other. The glass transition temperature of the core layer is preferably lower than that of the skin layer. In this case, the glass transition temperatures of both the skin and core are measured, and the average value obtained by calculation from the volume fraction thereof is defined as the aforementioned glass transition temperature Tg so that it is handled in the same manner. Further, the viscosity of the melt including the cellulose ester at the time of melt-casting can be different in the skin layer and core layer. The viscosity of the skin layer can be greater than that of the core layer. Alternatively, the viscosity of the core layer can be equal to or greater than that of the skin layer.

Assuming that the dimension of the film is the standard when left to stand for 24 hours at a temperature of 23° C. with a relative humidity of 55% RH. On this assumption, the dimensional stability of the cellulose acylate film of the present embodiment is such that the fluctuation of the dimension at 80° C. and 90% RH is within ±2.0% (excl.), preferably within ±1.0% (excl.), more preferably within ±0.5% (excl.).

When the cellulose acylate film of the present embodiment is used as a protective film of the polarizing plate as the retardation film, if the retardation film has a fluctuation in excess of the aforementioned range, the absolute value of the retardation and the orientation angle as a polarizing plate will deviate from the initial setting. This may cause reduction in the capability of improving the display quality, or may result in deterioration of the display quality.

The cellulose acylate film of the present invention can be used for the polarizing plate protective film. When used as a polarizing plate protective film, there is no restriction to the method of producing the polarizing plate. The polarizing plate can be manufactured by a commonly used method. The cellulose acylate film having been obtained is subjected to alkaline treatment. Using an aqueous solution of completely saponified polyvinyl alcohol, the polarizing plate protective films can be bonded on the both surfaces of the polarizer manufactured by immersing the polyvinyl alcohol film in an iodonium solution and by drawing the same. When this method is used, the retardation film as the polarizing plate protective film in the embodiment of the present invention is directly bonded to at least one of the surfaces of the polarizer.

Instead of the aforementioned alkaline treatment, the film can be provided with simplified adhesion as disclosed in JP-A No. 06-94915 and JP-A No. 06-118232.

The polarizing plate is made up of a polarizer and protective films for covering both surfaces thereof. Further, a film for protecting can be bonded onto one of the surfaces of the aforementioned polarizing plate and a release sheet can be bonded on the opposite surface. The film for protecting and the release sheet are used to protect the polarizing plate at the time of product inspection before shipment of the polarizing plate. In this case, the film for protecting is bonded to protect the surface of the polarizing plate, and is used on the surface opposite to the surface wherein the polarizing plate is bonded to the liquid crystal. Further, the release sheet is used to cover the adhesive layer to be bonded to the liquid crystal substrate, and is used on the surface wherein the polarizing plate is bonded to the liquid crystal cell.

### EXAMPLE

Referring to examples, the following specifically describes the embodiment of the present invention without the present invention being restricted thereto.

### Example 1

### Preparation of Cellulose Acylate

### Synthetic Example 1

To 30 g of cellulose (dissolved pulp; produced by Nihon Seishi Co., Ltd.,), 30 g of acetic acid was added, and then the resulting mixture was stirred at 54° C. for 30 minutes. After the mixture was cooled, 150 g of acetic anhydride and 1.2 g of sulfuric acid both of which were cooled in an ice water bath were added thereto so that esterification was carried out. In the esterification reaction, the reacting mixture was stirred for 150 minutes while controlling the temperature so as not to over 40° C. After termination of the reaction, a mixture of 30 g of acetic acid and 10 g of water was added dropwise over 20 minutes so that excessive anhydride was hydrolyzed. While the temperature of the reaction solution was maintained at 40° C., 90 g of acetic acid and 30 g of water were added and stirred for 1 hour. The mixture was put into an aqueous solution containing 2 g of magnesium acetate and stirred for some time. After that, the precipitate was filtered and dried to prepare Cellulose acylate C-1, which exhibited an acetyl substitution degree and a weight average molecular weight of 2.80 and 220,000, respectively.

### Synthetic Examples 2 to 8

Cellulose acylates C-2 to C-8 were prepared in the similar esterification operation to Synthetic example 1 except that acetic acid, acetic anhydride, propionic acid, propionic anhydride, butyric acid and butyric anhydride were used as shown in Table 1.

TABLE 1

| | | | | | Acyl group | | | Acyl | |
|---|---|---|---|---|---|---|---|---|---|
| | Fatty | | Fatty acid | | substitution | | | group | |
| Cellulose | acid | | anhydride | | degree | | | total | |
| acylate | I | II | I | II | Ac | Pr | Bu | carbon number | Mw |
| C-1 | 30 | 0 | 150 | 0 | 2.80 | 0.00 | — | 5.60 | 220000 |
| C-2 | 87 | 20 | 51 | 50 | 2.45 | 0.43 | — | 6.19 | 211000 |
| C-3 | 10 | 100 | 10 | 100 | 0.65 | 1.73 | — | 6.49 | 201000 |
| C-4 | 87 | 20 | 43 | 62 | 2.20 | — | 0.63 | 6.92 | 198000 |
| C-5 | 90 | 20 | 8 | 125 | 1.65 | 1.27 | — | 7.11 | 238000 |
| C-6 | 70 | 40 | 8 | 125 | 1.45 | 1.43 | — | 7.19 | 241000 |
| C-7 | 20 | 90 | 9 | 124 | 0.35 | 2.20 | — | 7.30 | 223000 |
| C-8 | 0 | 90 | 4 | 125 | 0.15 | 2.73 | — | 8.49 | 248000 |

Each additive described in abbreviation in Table 1 is detailed below.
<Acyl Group Substitution Degree>
Ac: Acetyl Group
Pr: Propionyl group
Bu: Butyryl group
<Fatty Acid>
I: Acetic acid
II: Propionic acid or butyric acid
<Fatty Acid Anhydride>
I: Acetic anhydride
II: Propionic anhydride or n-butyric anhydride
Mw: Weight average molecular weight (The weight average molecular weight was measured by GPC HLC-8220 manufactured by Tosoh Corp.)

### Synthetic Examples 9 to 41

Cellulose acylates C-9 to C-41 were prepared employing the similar fatty acids and fatty acid anhydrides to Synthetic example 1, except that the acyl group substitution degrees were changed to those described in Table 2.

TABLE 2

| | | |
|---|---|---|
| | Acyl group | Acyl group |
| Cellulose | substitution degree | total carbon |

| acylate | Ac | Pr | Bu | Pe | number |
|---|---|---|---|---|---|
| C-9 | 2.58 | — | — | — | 5.16 |
| C-10 | 0.35 | 1.62 | — | — | 5.56 |
| C-11 | 0.85 | 1.42 | — | — | 5.96 |
| C-12 | 1.35 | 1.08 | — | — | 5.94 |
| C-13 | 2.65 | 0.23 | — | — | 5.99 |
| C-14 | 2.65 | 0.27 | — | — | 6.11 |
| C-15 | 2.65 | — | 0.20 | — | 6.10 |
| C-16 | 2.65 | — | — | 0.16 | 6.10 |
| C-17 | 0.95 | 1.43 | — | — | 6.19 |
| C-18 | 1.65 | 0.97 | — | — | 6.21 |
| C-19 | 1.90 | — | 0.60 | — | 6.20 |
| C-20 | 2.00 | — | — | 0.44 | 6.20 |
| C-21 | 0.45 | 1.80 | — | — | 6.30 |
| C-22 | 1.25 | 1.27 | — | — | 6.31 |
| C-23 | 2.10 | — | 0.55 | — | 6.40 |
| C-24 | 1.15 | — | — | 0.85 | 6.55 |
| C-25 | 0.69 | 1.74 | — | — | 6.60 |
| C-26 | 0.35 | 2.03 | — | — | 6.79 |
| C-27 | 0.90 | 1.67 | — | — | 6.81 |
| C-28 | 1.35 | 1.37 | — | — | 6.81 |
| C-29 | 2.40 | — | — | 0.42 | 6.90 |
| C-30 | 0.65 | 1.90 | — | — | 7.00 |
| C-31 | 1.35 | — | — | 0.91 | 7.25 |
| C-32 | 1.05 | 1.73 | — | — | 7.29 |
| C-33 | 0.25 | 2.33 | — | — | 7.49 |
| C-34 | 0.55 | 2.13 | — | — | 7.49 |
| C-35 | 1.05 | 1.80 | — | — | 7.50 |
| C-36 | 1.85 | — | 0.95 | — | 7.50 |
| C-37 | 2.10 | — | — | 0.66 | 7.50 |
| C-38 | 0.10 | 2.60 | — | — | 8.00 |
| C-39 | 1.00 | — | 1.50 | — | 8.00 |
| C-40 | 1.20 | — | 1.65 | — | 9.00 |
| C-41 | 1.30 | — | — | 1.38 | 9.50 |

In Table 2, the abbreviations of Ac, Pr, and Bu used for the acyl group substitution degree indicate the same group as those in Table 1, and Pe denotes an n-pentanoyl group.

<<Preparation of Plasticizer>>

### Synthetic Example 42

As a plasticizer of a comparative example, trimethylol propane tribenzoate (TMPTB) was synthesized based on the method described below.

To a mixed solution of 54 parts by mass of trimethylol propane, 111 parts by mass of pyridine, and 650 parts by mass of toluene, whose temperature was maintained at 10° C., 170 parts by mass of benzoyl chloride were added dropwise over 30 minutes while stirring. After that, the resulting mixture was heated to 100° C. and stirred for 3 hours. After termination of the reaction, the temperature was lowered to room temperature, and the resulting precipitate was collected by filtration, washed by adding HCl aqueous solution of 1 mol/l, further washed by adding 1% Na₂CO₃ aqueous solution. Subsequently, the organic phase was collected, and then toluene was distilled out under vacuum, followed by purification to prepare PMPTB of white crystal having 160 parts by mass (at a yield of 90%).

### Synthetic Example 43

Synthetic example of Illustrated compound 1 is described below.

To a mixed solution of 37 parts by mass of glycerin, 111 parts by mass of pyridine, and 500 parts by mass of toluene, whose temperature was maintained at 10° C., 170 parts by mass of benzoyl chloride were added dropwise over 30 minutes while stirring. After that, the resulting mixture was heated to 100° C. and stirred for 3 hours. After termination of the reaction, the temperature was lowered to room temperature, and the resulting precipitate was collected by filtration, washed by adding HCl aqueous solution of 1 mol/l, further washed by adding 1% Na₂CO₃ aqueous solution. Subsequently, the organic phase was collected, and then toluene was distilled out under vacuum, followed by purification to prepare Illustrated compound 1 of white crystal having 143 parts by mass (at a yield of 89%).

### Synthetic Example 44

Synthetic example of Illustrated compound 2 is described below.

To a mixed solution of 37 parts by mass of glycerin, 111 parts by mass of pyridine, and 500 parts by mass of toluene, whose temperature was maintained at 10° C., 70 parts by mass of o-methoxy benzoyl chloride were added dropwise over 30 minutes while stirring. After that, the resulting mixture was heated to 100° C. and stirred for 3 hours. After termination of the reaction, the temperature was lowered to room temperature, and the resulting precipitate was collected by filtration, washed by adding HCl aqueous solution of 1 mol/l, further washed by adding 1% Na₂CO₃ aqueous solution. Subsequently, the organic phase was collected, and then toluene was distilled out under vacuum, followed by purification to prepare Illustrated compound 2 of clear liquid having 144 parts by mass (at a yield of 82%).

### Synthetic Example 45

Synthetic example of Illustrated compound 7 is described below.

To a mixed solution of 37 parts by mass of glycerin, 111 parts by mass of pyridine, and 500 parts by mass of toluene, whose temperature was maintained at 10° C., 205 parts by mass of p-methoxy benzoyl chloride were added dropwise over 30 minutes while stirring. After that, the resulting mixture was heated to 100° C. and stirred for 3 hours. After termination of the reaction, the temperature was lowered to room temperature, and the resulting precipitate was collected by filtration, washed by adding HCl aqueous solution of 1 mol/l, further washed by adding 1% Na₂CO₃ aqueous solution. Subsequently, the organic phase was collected, and then toluene was distilled out under vacuum, followed by purification to prepare Illustrated compound 7 of white crystal having 167 parts by mass (at a yield of 85%).

### Synthetic Example 46

Synthetic example of Illustrated compound 9 is described below.

To a mixed solution of 37 parts by mass of glycerin, 111 parts by mass of pyridine, and 500 parts by mass of toluene, whose temperature was maintained at 10° C., a solution of 500 parts by mass of toluene in which 238 parts by mass of acetyl salicyloyl chloride was dissolved were added dropwise over 30 minutes while stirring. After that, the resulting mixture was heated to 80° C. and stirred for 5 hours. After termination of the reaction, the temperature was lowered to room temperature, and the resulting precipitate was collected by filtration, washed by adding HCl aqueous solution of 1 mol/l, further washed by adding 1% Na₂CO₃ aqueous solution. Subsequently, the organic phase was collected, and then toluene was distilled out under vacuum, followed by purification to prepare Illustrated compound 9 of clear liquid having 185 parts by mass (at a yield of 80%).

### Synthetic Example 47

Synthetic example of Illustrated compound 21 is described below.

To a mixed solution of 37 parts by mass of glycerin, 111 parts by mass of pyridine, and 500 parts by mass of toluene, whose temperature was maintained at 10° C., a solution of 500 parts by mass of toluene in which 241 parts by mass of 3,5-dimethoxy benzoyl chloride was dissolved were added dropwise over 30 minutes while stirring. After that, the resulting mixture was heated to 100° C. and stirred for 3 hours. After termination of the reaction, the temperature was lowered to room temperature, and the resulting precipitate was collected by filtration, washed by adding HCl aqueous solution of 1 mol/l, further washed by adding 1% Na₂CO₃ aqueous solution. Subsequently, the organic phase was collected, and then toluene was distilled out under vacuum, followed by purification to prepare Illustrated compound 21 of clear liquid having 175 parts by mass (at a yield of 75%).

### Synthetic Example 48

Synthetic example of Illustrated compound 33 is described below.

To a mixed solution of 37 parts by mass of glycerin, 111 parts by mass of pyridine, and 500 parts by mass of toluene, whose temperature was maintained at 10° C., a solution of 500 parts by mass of toluene in which 277 parts by mass of 3,4,5-trimethoxy benzoyl chloride was dissolved were added dropwise over 30 minutes while stirring. After that, the resulting mixture was heated to 110° C. and stirred for 5 hours. After termination of the reaction, the temperature was lowered to room temperature, and the resulting precipitate was collected by filtration, washed by adding HCl aqueous solution of 1 mol/l further washed by adding 1% Na₂CO₃ aqueous solution. Subsequently, the organic phase was collected, and then toluene was distilled out under vacuum, followed by purification to prepare Illustrated compound 33 of white crystal having 224 parts by mass (at a yield of 83%).

Other Illustrated compounds listed in Table 3 were synthesized in a similar manner to the procedure of each synthetic example above.

<<Preparation of Film>>

[Preparation of Film F-5]

A mixture of 100 parts by mass of Cellulose acylate C-5, 0.5 parts by mass of Stabilizer A-1, 1.0 part by mass of UV absorber TINUVIN 928 (produced by Ciba Specialty Chemicals CO.)ᵣ and 0.3 parts by mass of AEROSIL R927V (Produced by Nihon Aerosil Co., Ltd.) as a matting agent was prepared. Subsequently, into the above mixture, 15 parts by mass of the above-described Illustrated compound 1 as a plasticizer was added and the mixture was blended, which was then dried under reduced pressure at 60° C. for 5 hours. The resulting cellulose acylate composite was melted and mixed at 235° C. using a twin screw extruder to prepare pellets. During the process, an all-screw type screw was utilized without utilizing a kneading disk to suppress heat generation due to shearing during kneading. Further, vacuuming was carried out through a vent hole, and the volatile components generated during kneading were removed by vacuum suction. To prevent moisture from being absorbed into the resin, spaces of the feeder and the hopper for supplying the resin to the extruder and the space between the extrusion die and the cooling tank were filled with dry nitrogen gas.

The film formation was carried out by the film manufacturing apparatus shown in FIG. 1. The first cooling roll and the second cooling roll were made of stainless steel having a diameter of 40 cm, and the surface was plated with hard chromium. The temperature regulating oil was circulated inside the roll to control the roll surface temperature. The elastic touch roll had a diameter of 20 cm, and the inner sleeve and outer sleeve were made of stainless steel. The surface of the outer sleeve was plated with hard chromium. The outer sleeve was 2 mm thick, and temperature regulating oil was circulated in the space between the inner sleeve and the outer sleeve to control the surface temperature of the elastic touch roll.

The pellets (the water content: 50 ppm) thus prepared was melt-extruded from a T-die at a melt film formation temperature of 240° C., using a single screw extruder, in the form of a film onto the first cooling roll having a surface temperature of 130° C., to obtain a cast film at a draw ratio of 20. In the above procedure, a T-die exhibiting a lip clearance of 1.5 mm and an average lip surface roughness Ra of 0.01 μm was employed.

Further, the film was pressed onto the first cooling roll using the elastic touch roll having a metallic surface layer of 2 mm in thickness at a linear pressure of 100 N/cm. The film temperature on the side facing the touch roll at the time of pressing was 180° C.±1° C. The term “film temperature on the side facing the touch roll at the time of pressing” refers to the average value of the film surface temperatures of the film at the position in contact with the touch roll on the first roll (cooling roll), wherein the film surface temperature was measured at ten positions across the width via a non-contact thermometer which was 50 cm from the film surface by retracting the touch roll as necessary. The glass transition temperature Tg of this film was 136° C. The glass transition temperature of a film extruded from a die was measured using the DSC 6200 of Seiko Inc via the DSC method (at a rising temperature of 10° C./minute in nitrogen gas).

The surface temperature of the elastic touch roll was set to 130° C., and that of the second cooling roll was set to 100° C. Each surface temperature reading of the elastic touch roll, the first cooling roll, and the second cooling roll was the average of the temperatures of the roll surface measured at ten points across the width via a non-contact thermometer. The measured points on the roll surface were 90 degrees upstream in the rotational direction from the point where the film first contacts the roll.

The film thus produced was heated at 160° C. and drawn 1.05 times in the longitudinal direction by a roll drawing. Then the film was introduced into a tenter having a preheating zone, a drawing zone, a holding zone and a cooling zone (a neutral zone was also provided between each zone to ensure heat insulation between zones), and cooled down to 70° C. while being relaxed by 2% in the width direction after drawn by 1.20 times in the width direction at 160° C. After that, the film was released from clips, and the clipped portions were trimmed off, and then both edges of the film are provided with knurling of 10 mm in width and 5 μm in height, to prepare Cellulose acylate optical film F-5 with being slit in 1,430 mm in width exhibiting 80 μm in film thickness, 5 nm of Ro and 45 nm of Rt. During the above preparation, the preheating temperature and holding temperature were controlled to prevent the bowing phenomenon due to drawing.

[Preparation of Films F-1 to F-4 and F-6 to F-41]

Films F-1 to F-4 and F-6 to F-41 were prepared in the similar manner to the preparation of the above Film F-5 except that kinds of cellulose acylate, plasticizer (polyalcohol ester compounds were indicated by illustrated compound numbers), Stabilizers 1 to 3, and film formation temperature were changed to those described in Table 3, and further, an indication whether the elastic touch roll was used or not was described in Table 3 in Table 3, the added amounts of Stabilizer-1, Stabilizer-2, and Stabilizer-3 were set to 0.5 parts by mass, 0.25 parts by mass, and 0.25 parts by mass, respectively. In preparation of each film, amounts of extrusion and taking up rate were appropriately controlled so that the film thickness was 80 μm.

TABLE 3

| | | | | | | Film formation | | |
|---|---|---|---|---|---|---|---|---|
| Film | Cellulose | | | | | temperature | Elastic | |
| No. | acylate | *1 | Stabilizer-1 | Stabilizer-2 | Stabilizer-3 | (° C.) | touch roll | Remarks |
| F-1 | C-1 | TPP | A-1 | — | — | 240 | Used | Comp. |
| F-2 | C-2 | TPP | A-1 | A-3 | — | 250 | Used | Comp. |
| F-3 | C-3 | TPP | A-1 | A-5 | A-6 | 240 | Used | Comp. |
| F-4 | C-4 | TMPTB | A-1 | — | — | 250 | Used | Comp. |
| F-5 | C-5 | 1 | A-1 | — | — | 240 | Used | Inv. |
| F-6 | C-6 | 7 | A-1 | A-5 | A-6 | 240 | Used | Inv. |
| F-7 | C-7 | 21 | A-1 | A-3 | — | 240 | Used | Inv. |
| F-8 | C-8 | 2 | A-1 | — | — | 230 | Used | Inv. |
| F-9 | C-9 | 1 | A-1 | — | — | 260 | Not used | Comp. |
| F-10 | C-10 | 7 | A-1 | A-5 | A-6 | 240 | Not used | Comp. |
| F-11 | C-11 | 15 | A-1 | A-3 | — | 230 | Used | Inv. |
| F-12 | C-12 | 1 | A-1 | A-5 | A-6 | 240 | Used | Inv. |
| F-13 | C-13 | 7 | A-2 | — | — | 250 | Used | Inv. |
| F-14 | C-14 | 7 | A-1 | A-5 | A-6 | 250 | Not used | Comp. |
| F-15 | C-15 | 9 | A-2 | A-5 | A-6 | 250 | Used | Inv. |
| F-16 | C-16 | 33 | A-1 | A-4 | A-5 | 250 | Used | Inv. |
| F-17 | C-17 | 18 | A-1 | A-4 | — | 240 | Used | Inv. |
| F-18 | C-18 | 7 | A-1 | A-5 | A-6 | 250 | Not used | Comp. |
| F-19 | C-19 | 3 | A-2 | — | — | 250 | Used | Inv. |
| F-20 | C-20 | 5 | A-1 | A-3 | — | 250 | Used | Inv. |
| F-21 | C-21 | 1 | A-1 | A-4 | A-5 | 240 | Used | Inv. |
| F-22 | C-22 | 78 | A-1 | A-6 | — | 240 | Used | Inv. |
| F-23 | C-23 | 1 | A-2 | A-6 | — | 240 | Used | Inv. |
| F-24 | C-24 | 48 | A-2 | A-3 | — | 240 | Used | Inv. |
| F-25 | C-25 | 51 | A-2 | A-5 | — | 240 | Used | Inv. |
| F-26 | C-26 | 1 | A-1 | A-5 | A-6 | 240 | Not used | Comp. |
| F-27 | C-27 | 7 | A-1 | A-4 | A-5 | 240 | Used | Inv. |
| F-28 | C-28 | 76 | A-1 | A-3 | — | 240 | Used | Inv. |
| F-29 | C-29 | 1 | A-1 | A-6 | — | 240 | Used | Inv. |
| F-30 | C-30 | 2 | A-6 | A-5 | — | 240 | Used | Inv. |
| F-31 | C-31 | 6 | A-1 | A-7 | — | 240 | Used | Inv. |
| F-32 | C-32 | 13 | A-2 | A-7 | — | 240 | Used | Inv. |
| F-33 | C-33 | 1 | A-1 | A-5 | A-6 | 240 | Not used | Comp. |
| F-34 | C-34 | 24 | A-1 | A-4 | A-7 | 240 | Used | Inv. |
| F-35 | C-35 | 25 | A-1 | A-3 | — | 240 | Used | Inv. |
| F-36 | C-36 | 7 | A-1 | A-5 | A-6 | 240 | Used | Inv. |
| F-37 | C-37 | 1 | A-1 | A-7 | A-6 | 240 | Used | Inv. |
| F-38 | C-38 | 80 | A-1 | A-4 | A-7 | 240 | Used | Inv. |
| F-39 | C-39 | 7 | A-1 | A-7 | A-6 | 240 | Used | Inv. |
| F-40 | C-40 | PETB | A-1 | A-5 | A-6 | 240 | Used | Comp. |
| F-41 | C-41 | TMPTB | A-1 | A-5 | A-6 | 250 | Not used | Comp. |

*1: Plasticizer,
Comp.: Comparative example,
Inv.: Present invention
Each compound given in abbreviation in Table 3 is detailed below.
<Plasticizer>
TPP: triphenyl phosphate (produced by Aldrich Co.)
TMPTB: trimethylol propane tribenzoate (Synthetic example 42)
PETB: pentaerythritol tetrabenzoate (produced by Aldrich Co.)
<Stabilizer>
A-1: IRGANOX-1010 (produced by Ciba Specialty Chemicals Inc.)
A-2: TINUVIN 144 (produced by Ciba Specialty Chemicals Inc.)
A-3: SUMILAIZER GP (produced by Sumitomo Chemical Co., Ltd.)
A-4: LA-52 (produced by ADEKA Corp.)
A-5: PEP-36 (produced by ADEKA Corp.)
A-6: HP-136 (produced by Ciba Specialty Chemicals Inc.)
A-7: GSY-P101 (produced by API Corp.)

<<Alkaline Saponification Treatment of Film>>

In the saponification of the film prepared above, saponification, rinsing, neutralization and rinsing were carried out in that order under the following conditions, and the resulting film was dried at 80° C., to prepare a saponified film.

Saponification step: with 2 mol/l of sodium hydroxide at 50° C. and 90 seconds

Rinsing step: with water at 30° C. and 45 seconds

Neutralization step: with 10% by mass of hydrochloric acid at 30° C. and 45 seconds

Rinsing step: with water

<<Evaluation of Film>>

Various evaluations on the film were carried out according to the methods below.

[Evaluation of Film Mechanical Strength]

The rupture elongation of the film in the film formation direction was determined at 23° C. and 50% RH using a mechanical strength tester TESSILON. The evaluation was made according to the following criteria:

A: The rupture elongation is 30% or more.
B: The rupture elongation is 20% or more and less than 30%.
C: The rupture elongation is 10% or more and less than 20%.
D: The rupture elongation is less than 10%.

[Evaluation of Saponifiability]

To evaluate the saponifiability, the static contact angle of the saponified film surface with water was determined. The static contact angle was measured via the θ/2 method using an automatic surface tensiometer (CA-V made by Kyowa Kaimenkagaku Co., Ltd.). The average value of five measurements in the width direction was used as the evaluation value. The evaluation was made according to the following criteria for rating the static contact angle.

A: less than 35 degrees
B: 35 degrees or more and less than 45 degrees
C.; 45 degrees or more and less than 50 degrees
D; 50 degrees or more

[Evaluation of Melt Film Formation Performance]

The film thickness was determined at ten points at 5 cm intervals in the longitudinal and width directions, and the standard deviation of the film thickness was calculated. Evaluation was made according to the following criteria for standard deviation:

A: less than 2 μm
B: 2 μm or more and less than 5 μm
C: 5 μm or more and less than 10 μm
D: 10 μm or more

[Determination of Moisture Permeability]

The moisture permeability was determined at 40° C. and 90% RH, according to the procedure specified in the JIS Z0208. Evaluation was made according to the following criteria for moisture permeability:

A: less than 500 g/m²/day
B: 500 g/m²/day or more and less than 600 g/m²/day
C: 600 g/m²/day or more and less than 700 g/m²/day
D: 700 g/m²/day or more

[Evaluation of Bleedout]

After the film was conditioned at 23° C. and 55% RH, the film was subjected to a wiping test using a waste cloth and a bleeding test using a felt tipped pen. Evaluation was made according to the following criteria for bleedout:

A: No wiping marks were produced on the film surface after wiping the surface with a waste cloth, and further no bleeding was observed on the film after a felt tipped pen was applied thereon.
B: Any one of the above two phenomena was observed to a slight degree.
C: Any one of the above phenomena was observed to a significant degree.

[Determination of YI]

The absorption spectrum of each film prepared above was determined using a Spectrophotometer U-3310, produced by Hitachi High Technologies Co., Ltd., and the tristimulus values X, Y and Z were calculated. Based on these tristimulus values X, Y and Z, the yellow index YI was calculated according to the method of JIS-K 7103. Evaluation was made according to the following criteria for the yellow index YI:

A: less than 1.0
B: 1.0 or more and less than 2.0
C: 2.0 or more and less than 4.0
D: more than 4.0

[Evaluation of Flatness]

Each sampling was made at a time when one hour had passed since the melt film formation process had started, and a sample of 100 cm in length×40 cm in width was cut out.

A sheet of black paper was applied on a flat surface desk, and each of the above samples was placed thereon. The reflected images of three straight fluorescent tubes, which were positioned obliquely above the sample, were reflected on the film, and the flatness of the sample was evaluated by observing the degree of bending of the reflected images of the fluorescent tubes. The flatness was evaluated based on the following criteria:

A: All three reflected images of the tubes appear straight.
B: The reflected images appear slightly bent at some portions.
C: The reflected images appear slightly bent along the full length of the tubes.
D: The reflected images appear significantly bent along the full length of the tubes.

[Evaluation of Horseback Failure]

The evaluation was made in the following way: After Cellulose ester film web material 120 was wound onto Winding core 110, it was wrapped twice by a polyethylene sheet, which was then held on Support plate 117 provided on Supporting counter 118, and stored in a box. Then the web material in the box was stored at 25° C. and 50% RH for 30 days. After that, the web material was taken out from the box, and the polyethylene sheet was taken away. The lighted fluorescent lamp tube was reflected on the surface of Cellulose ester film web material 120, and distortion or slight irregularities of the image were observed. Then, the horseback failure was evaluated according to the following criteria:

A: The reflected image of the tube appears straight.
B: The reflected image appears slightly bent at some portions.
C: The image appears partially slightly bent along the full length of the tube.
D: The image appears in pieces.
Each result of evaluation obtained above is given in Table 4.

TABLE 4

| | Evaluation results | | | | | | | | |
|---|---|---|---|---|---|---|---|---|---|
| | | | Melt film | | | | | | |
| Film | Mechanical | | formation | | Moisture | Bleed- | | Horseback | |
| No. | strength | Saponifiability | performance | Flatness | Permeability | out | YI | failure | Remarks |
| F-1 | D | B | D | D | D | D | D | D | Comp. |
| F-2 | B | C | D | C | D | D | C | D | Comp. |
| F-3 | D | D | B | C | D | D | C | C | Comp. |
| F-4 | C | C | D | C | C | D | D | D | Comp. |
| F-5 | A | A | B | A | B | A | B | A | Inv. |
| F-6 | A | A | B | A | A | B | A | A | Inv. |
| F-7 | B | B | A | A | B | B | A | A | Inv. |
| F-8 | B | C | A | A | B | B | B | B | Inv. |
| F-9 | D | B | D | D | C | B | D | D | Comp. |
| F-10 | D | D | C | D | B | C | C | D | Comp. |
| F-11 | B | C | B | B | B | B | A | B | Inv. |
| F-12 | B | B | C | B | B | A | A | B | Inv. |
| F-13 | B | B | C | B | A | B | B | B | Inv. |
| F-14 | C | D | D | D | B | C | B | D | Comp. |
| F-15 | B | B | B | B | B | B | A | B | Inv. |
| F-16 | B | B | B | B | B | B | A | B | Inv. |
| F-17 | B | B | A | A | B | B | B | A | Inv. |
| F-18 | B | D | D | D | B | C | B | D | Comp. |
| F-19 | A | A | B | A | B | B | B | A | Inv. |
| F-20 | A | A | B | A | B | B | A | A | Inv. |
| F-21 | B | B | A | A | B | A | A | A | Inv. |
| F-22 | A | A | B | A | B | B | B | A | Inv. |
| F-23 | A | A | B | A | B | A | B | A | Inv. |
| F-24 | A | A | B | A | B | B | A | A | Inv. |
| F-25 | B | B | A | A | B | B | A | A | Inv. |
| F-26 | D | D | B | D | C | B | B | C | Comp. |
| F-27 | B | B | A | A | A | B | A | A | Inv. |
| F-28 | A | A | B | A | B | B | A | A | Inv. |
| F-29 | A | A | B | A | B | A | B | A | Inv. |
| F-30 | B | B | A | A | B | B | A | A | Inv. |
| F-31 | A | A | B | A | B | B | A | A | Inv. |
| F-32 | B | B | A | A | B | B | A | A | Inv. |
| F-33 | D | D | B | D | C | B | B | C | Comp. |
| F-34 | B | B | A | A | B | B | A | A | Inv. |
| F-35 | B | B | A | A | B | B | A | A | Inv. |
| F-36 | A | A | B | A | A | B | A | A | Inv. |
| F-37 | A | A | B | A | B | A | A | A | Inv. |
| F-38 | B | C | B | B | B | B | A | B | Inv. |
| F-39 | B | C | B | B | A | B | A | B | Inv. |
| F-40 | D | C | C | D | D | D | B | D | Comp. |
| F-41 | D | C | C | D | C | C | B | C | Comp. |

Comp.: Comparative example,
Inv.: Present invention

### Example 2

### Preparation of Polarizing Plate

The cellulose acylate films F1 to F41 prepared in Example 1 were subjected to the following treatment of alkaline saponification to prepare the corresponding Polarizing plates 1 to 41.

[Alkaline Saponification Treatment]

Saponification step: with 2 mol/l of sodium hydroxide at 50° C. and 90 seconds

Rinsing step: with water at 30° C. and 45 seconds

Neutralization step: with 10% by mass of hydrochloric acid at 30° C. and 45 seconds

Rinsing step: with water

After the saponification treatment, rinsing, neutralization and rinsing were carried out in that order, and the resulting film was dried at 80° C.

[Preparation of Polarizer]

A long roll polyvinyl alcohol film of 120 μm in thickness was immersed in 100 parts by mass of aqueous solution containing 1 part by mass of iodine and 4 parts by mass of boric acid, which was then drawn 6 times in the film conveying direction at 50° C., to prepare a polarizer.

The cellulose acylate films having being subjected to alkaline saponification treatment were bonded, using an aqueous solution containing 5% by mass of fully saponified polyvinyl alcohol as an adhesive, to both sides of the polarizer wherein the surface treated by alkaline saponification was placed on the polarizer side, to prepare Polarizing plate 1 to 41 on which polarizing plate protective films were bonded.

<<Evaluation of Characteristics as Liquid crystal display device>>

The polarizing plate of the 32 TFT Type color liquid crystal display VEGA (manufactured by Sony Corp.) was stripped off, and each of the polarizing plates prepared above was cut to the size of the liquid crystal cell. Two such polarizing plates prepared as above were bonded to sandwich the liquid crystal cell, wherein the aforesaid two polarizing plates were disposed perpendicular to each other so that the polarizing axis of the polarizing plate was the same as the original, to reproduce a 32 TFT Type color liquid crystal display. Then the characteristics of the cellulose acylate film as a polarizing plate were evaluated. The results demonstrated that the polarizing plate prepared from the cellulose acylate film of the present invention exhibited high contrast and excellent display performances, which verified that the cellulose acylate film of the present invention was excellent as a polarizing plate for an image display apparatus such as a liquid crystal display.

1-13. (canceled)

14. A method for producing a cellulose acylate film via a melt casting film formation method comprising the steps of:
extruding a cellulose acylate and at least one compound represented by Formula (1) from a casting die to form the cellulose acylate film; and
pressing the formed cellulose acylate film between a touch roll whose surface is elastically deformable and a cooling roll: 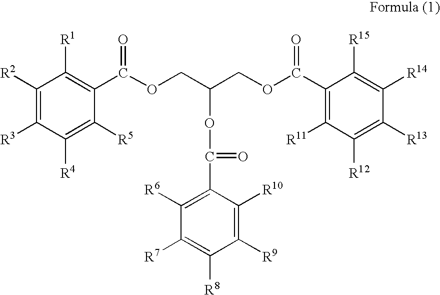
wherein each of R₁ to R₁₅ independently represents a hydrogen atom, a cycloalkyl group, an aralkyl group, an alkoxy group, a cycloalkoxy group, an aryloxy group, an aralkyloxy group, an acyl group, a carbonyloxy group, an oxycarbonyl group, or oxycarbonyloxy group, provided that said groups may further be substituted with a substituent.

15. The method for producing a cellulose acylate film of claim 14, wherein the cellulose acylate film incorporates a compound represented by Formula (1) in an amount of from 1% to 25% by mass.

16. The method for producing a cellulose acylate film of claim 14, wherein the cellulose acylate employed in the production of the above cellulose acylate film exhibits an acyl group total carbon number (a sum of products of a substitution degree of each acyl group substituted into a glucose unit in the cellulose acylate and a number of carbon atoms in the acyl group) of from 6.2 to 7.5.

17. The method for producing a cellulose acylate film of claim 16, wherein the cellulose acylate has a total substitution degree of acyl groups of 2.95 or less.

18. The method for producing a cellulose acylate film of claim 14, wherein the above cellulose acylate incorporates as a substituent at least one selected from the group consisting of an acetyl group, a propionyl group, a butyryl group, and an n-pentanoyl group.

19. The method for producing a cellulose acylate film of claim 14, wherein the cellulose acylate film incorporates at least one selected from the group consisting of a hindered phenol antioxidant, a phosphorous antioxidant, and a carbon radical scavenger.

20. The method for producing a cellulose acylate film of claim 19, wherein the cellulose acylate film incorporates a lactone compound as the carbon radical scavenger.

21. The method for producing a cellulose acylate film of claim 14, wherein an extrusion temperature from the casting die of the cellulose acylate is from 200° C. to 300° C.

22. The method for producing a cellulose acylate film of claim 21, wherein an extrusion temperature from the casting die of the cellulose acylate is from 230° C. to 260° C.

23. The method for producing a cellulose acylate film of claim 14, wherein a line pressure between the touch roll and the cooling roll is from 10 N/cm to 150 N/cm.

24. A cellulose acylate film produced by the method of claim 14.

25. A polarizing plate, wherein the cellulose acrylate film of claim 24 is employed as a polarizing plate protective film.

26. A liquid crystal display device comprising the polarizing plate of claim 25.
